(19) United States
(12) Patent Application Publication
(10) Pub. No.: US 2023/0351148 A1
(43) Pub. Date: Nov. 2, 2023

(54) EXPLAINABLE MACHINE LEARNING SYSTEMS AND METHODS FOR DATA DISCOVERY AND INSIGHT GENERATION

(71) Applicant: Mined XAI, LLC, Bellbrook, OH (US)

(72) Inventors: Ryan Kramer, Bellbrook, OH (US); Kyle Siegrist, Cincinnati, OH (US)

(73) Assignee: Mined XAI, LLC, Bellbrook, OH (US)

(21) Appl. No.: 18/141,338

(22) Filed: Apr. 28, 2023

Related U.S. Application Data
(60) Provisional application No. 63/363,800, filed on Apr. 28, 2022.

(51) Int. Cl. G06N 3/04

(52) U.S. Cl. CPC G06N 3/04

(57) ABSTRACT

An example method comprises projecting analysis data to a first embedding based on at least one metric, determining a first lowest cover resolution that identifies non-overlapping secondary coverings based on sets within one of the covers, identifying a branch point based on the non-overlapping secondary coverings, generating subsets from the branch point, for each subset from the branch point, determining a second lowest cover resolution that identifies non-overlapping secondary coverings to identify a new branch point and new subsets from that branch point of the first connected-component network, for each leaf of the connected-component network, identify embeddings of a feature space and generate a local object embedding space using the transposition of segmented features with related objects, adding coordinates of objects within each leaf of the local object embedding to a data array, projecting array data to a second embedding, determining a third lowest cover resolution of the second embedding that identifies non-overlapping secondary coverings based on sets within one of the covers of the second embedding, identifying a branch point of a second connected-component network based on the non-overlapping secondary coverings, generating subsets from the branch point, for each subset from the branch point, determining a second lowest cover resolution that identifies non-overlapping secondary coverings based on the sets within one of the covers of a particular subset to identify a new branch point and new subsets from that branch point of the second connected-component network, and generating a visualization depicted centroids of leaves and branches within the second connected-component network.

### CROSS-REFERENCE TO RELATED APPLICATION

This application claims priority to U.S. Provisional Pat. Application No. 63/363,800, filed on Apr. 28, 2022, and entitled “Systems and Methods for Explainable AI,” which is incorporated in its entirety herein by reference.

### FIELD OF THE INVENTION(S)

Embodiments of the present invention(s) are generally related to insight discovery using artificial intelligence approaches for report and visualization of insights and in particular, to generating component-connected architectures of underlying data to generate explainable insights.

### BACKGROUND

As the collection and storage of data have increased, there is an increased need to analyze the data for explainable insights. Examples of large datasets may be found in financial services companies, flavor analysis, biotech, and academia. Unfortunately, previous methods of analysis of large multidimensional datasets tend to be insufficient (if possible at all) to identify important relationships.

Previous methods of analysis often use clustering. Clustering is generally too blunt an instrument to identify important relationships in the data (i.e., inherent relationships in the data may be lost within the analysis or noise created by the approach). Similarly, linear regression, projection pursuit, principal component analysis, and multidimensional scaling often do not reveal important relationships. Existing linear algebraic and analytic methods are too sensitive to large-scale distances and, as a result, lose detail.

### SUMMARY

An example non-transitory computer-readable medium comprises executable instructions. The executable instructions may be executable by one or more processors to perform a method. An example method may comprise receiving analysis data from at least one data source, projecting the analysis data to a first embedding based on at least one metric, determining a first lowest cover resolution of the first embedding that identifies non-overlapping secondary coverings based on sets within one of the covers of the first embedding, identifying a branch point of a first connected-component network based on the non-overlapping secondary coverings, generating subsets from the branch point based on the non-overlapping secondary coverings, if a network generation threshold has not been met, then for each subset from the branch point, determining a second lowest cover resolution that identifies non-overlapping secondary coverings based on the sets within one of the covers of a particular subset to identify a new branch point and new subsets from that branch point of the first connected-component network, for each leaf of the connected-component network, identify embeddings of a feature space and generate a local object embedding space using the transposition of segmented features with related objects, adding coordinates of objects within each leaf of the local object embedding to a data array, projecting array data from the data array to a second embedding, determining a third lowest cover resolution of the second embedding that identifies non-overlapping secondary coverings based on sets within one of the covers of the second embedding, identifying a branch point of a second connected-component network based on the non-overlapping secondary coverings, generating subsets from the branch point based on the non-overlapping secondary coverings,

if a network generation threshold has not been met, then for each subset from the branch point, determining a second lowest cover resolution that identifies non-overlapping secondary coverings based on the sets within one of the covers of a particular subset to identify a new branch point and new subsets from that branch point of the second connected-component network, and generating a visualization depicted centroids of leaves and branches within the second connected-component network.

The method may further comprise generating the secondary coverings by determining, for each set that has data within the cover, a centroid and determining a radius based on the centroid that covers at least that particular set. The centroid for a particular set may be determined based on the data within that particular set.

The first embedding may comprise a metric space containing projected data, the projected data being one-to-one in the first embedding. The new branch points and new segments may be determined based on new non-overlapping secondary coverings until the network generation threshold is met. In some embodiments, projecting the array data from the data array to the second embedding uses at least the same metric as projecting the received data to the first embedding.

In some embodiments, for each leaf of the first connected-component network, the method comprises projecting the leaf data of that leaf into a separate embedding and determining non-overlapping secondary coverings at the lowest resolution covering of that particular separate embedding to identify metafeature groups. The object membership of each metafeature group of each leaf may be added to the data array. The object membership of each metafeature group of each leaf may be added to the data array before projecting the array data from the data array to the second embedding.

An example system may comprise at least one processor and memory containing instructions. The instructions may be executable by the at least one processor to receive analysis data from at least one data source, project the analysis data to a first embedding based on at least one metric, determine a first lowest cover resolution of the first embedding that identifies non-overlapping secondary coverings based on sets within one of the covers of the first embedding, identify a branch point of a first connected-component network based on the non-overlapping secondary coverings, generate subsets from the branch point based on the non-overlapping secondary coverings, if a network generation threshold has not been met, then for each subset from the branch point, determine a second lowest cover resolution that identifies non-overlapping secondary coverings based on the sets within one of the covers of a particular subset to identify a new branch point and new subsets from that branch point of the first connected-component network, for each leaf of the connected-component network, identify embeddings of a feature space and generate a local object embedding space using the transposition of segmented features with related objects, add coordinates of objects within each leaf of the local object embedding to a data array, project array data from the data array to a second embedding, determine a third lowest cover resolution of the second embedding that identifies non-overlapping secondary coverings based on sets within one of the covers of the second embedding, identify a branch point of a second connected-component network based on the non-overlapping secondary coverings, generate subsets from the branch point based on the non-overlapping secondary coverings, if a network generation threshold has not been met, then for each subset from the branch point, determine a second lowest cover resolution that identifies non-overlapping secondary coverings based on the sets within one of the covers of a particular subset to identify a new branch point and new subsets from that branch point of the second connected-component network, and generate a visualization depicted centroids of leaves and branches within the second connected-component network.

An example method may comprise receiving analysis data from at least one data source, projecting the analysis data to a first embedding based on at least one metric, determining a first lowest cover resolution of the first embedding that identifies non-overlapping secondary coverings based on sets within one of the covers of the first embedding, identifying a branch point of a first connected-component network based on the non-overlapping secondary coverings, generating subsets from the branch point based on the non-overlapping secondary coverings, if a network generation threshold has not been met, then for each subset from the branch point, determining a second lowest cover resolution that identifies non-overlapping secondary coverings based on the sets within one of the covers of a particular subset to identify a new branch point and new subsets from that branch point of the first connected-component network, for each leaf of the connected-component network, identify embeddings of a feature space and generate a local object embedding space using the transposition of segmented features with related objects, adding coordinates of objects within each leaf of the local object embedding to a data array, projecting array data from the data array to a second embedding, determining a third lowest cover resolution of the second embedding that identifies non-overlapping secondary coverings based on sets within one of the covers of the second embedding, identifying a branch point of a second connected-component network based on the non-overlapping secondary coverings, generating subsets from the branch point based on the non-overlapping secondary coverings, if a network generation threshold has not been met, then for each subset from the branch point, determining a second lowest cover resolution that identifies non-overlapping secondary coverings based on the sets within one of the covers of a particular subset to identify a new branch point and new subsets from that branch point of the second connected-component network, and generating a visualization depicted centroids of leaves and branches within the second connected-component network.

### BRIEF DESCRIPTION OF THE DRAWINGS

FIG. 1 depicts an overview of construction of a network for explanation generation in some embodiments.

FIG. 2 depicts an example environment for an explainable machine learning system in some embodiments.

FIG. 3 depicts a block diagram of an explainable machine learning system in some embodiments.

FIG. 4A depicts a method for generating explainable insights using component-connected architecture(s) in some embodiments.

FIG. 4B depicts a method for generating component-connected architectures in some embodiments.

FIG. 5 depicts an initial approximation of the recursive hierarchical decomposition (RHD) of the dataset in some embodiments.

FIG. 6 depicts a tower of covers utilizing stepwise resolution increases in some embodiments.

FIG. 7 depicts subspace clustering of feature space in some embodiments.

FIG. 8 depicts a recursive hierarchical decomposition (e.g., a first connected-component network) of the feature space in some embodiments.

FIG. 9 depicts a reference frame context in some embodiments.

FIG. 10 depicts a second layer of the network (e.g., DTNN) in some embodiments.

FIG. 11 depicts the optional creation of metafeatures to explain segmentation in some embodiments.

FIG. 12 depicts the explanation element showing group membership for a local feature space in some embodiments.

FIG. 13 depicts the utilization of local embedding coordinates as novel features across the local transposed elements in some embodiments.

FIG. 14 depicts local clustering group information that is encoded as membership to hierarchically defined groups in some embodiments.

FIG. 15 depicts creation of an RHD summary in some embodiments.

FIG. 16 depicts leaf node centroids of global object space RHD in some embodiments.

FIG. 17 depicts subset node centroids of global object space RHD 1704 in some embodiments.

FIG. 18 depicts leaf and subset centroid placements within the embedding for each layer of the RHD in some embodiments.

FIG. 19 depicts a topological summary of global object space RHD 1902 in some embodiments.

FIG. 20 depicts an interactive visualization of the topological summary in some embodiments.

FIG. 21 depicts a statistical feature and metafeature summary of the RHD leaf node in some embodiments.

FIG. 22 depicts the hybrid EET1/EET2 showing group membership for selected local object space feature(s) in some embodiments.

FIG. 23 depicts an interactive visualization in some embodiments.

FIG. 24 is an example of a feature description for bourbons that is derived from the feature space RHD.

FIG. 25 depicts an example UMAP pre-embedding (HDBSCAN clusters).

FIG. 26 depicts an example UMAP pre-embedding (run order).

FIG. 27 depicts an example UMAP post-embedding (HDBSCAN clusters).

FIG. 28 depicts an example UMAP post-embedding (run order).

FIG. 29 depicts an example original spectra (control sequence). In this example, intensity is along the y-axis and retention time normalized spectra is along the x-axis.

FIG. 30 depicts an example retention time normalized spectra (run order) along the x-axis and intensity along the y-axis.

FIG. 31 depicts an example retention time normalized spectra (run order) along the x-axis and intensity along the y-axis.

FIG. 32 depicts an example retention time along the x-axis and intensity along the y-axis.

FIG. 33 depicts example spectra quotients (e.g., from the gas chromatograph). Median quotients are along the y-axis and the retention time (median quotient regression) is along the x-axis.

FIG. 34 depicts an example graph of SOP and control with the median quotient along the y-axis and the barrel number (e.g., for the specific barrel of bourbon) along the x-axis.

FIG. 35 depicts an example wheat-to-rye graph.

FIG. 36 depicts a proof 105 to proof 125 graph.

FIG. 37 depicts an example graph for seasoning of staves (e.g., comparison of 6 to 12 months).

FIG. 38 depicts an example graph of grain comparison (e.g., tight, average, coarse, and control).

FIG. 39 depicts an example storage graph for comparison of wooden to concrete).

FIG. 40 depicts an example char graph for comparing type #3 char to type #4 char.

FIG. 41 depicts an example tree graph for comparison of top of tree to bottom of tree.

FIG. 42 depicts an example ring graph for comparison of the number of rings.

FIG. 43 depicts a run order graph for a comparison of different run orders.

FIG. 44 depicts an example distill graph for comparison of different distillation dates.

FIG. 45 depicts a block diagram of an example digital device 4500 according to some embodiments.

Throughout the drawings, like reference numerals will be understood to refer to like parts, components, and structures.

### DETAILED DESCRIPTION

As discussed herein, various embodiments of systems and methods include generation of a component-connected architecture. Components of the component-connected architecture may define features, feature/object metadata, and/or object relationships. The component-connected architecture may enable the discovery of relationships of features within high-dimensional spaces.

In one example of the component-connected architecture, dimensionality-reduced feature sets are used to create a local transpose of the isolated features to derive local relationships of the objects within the feature space. A hierarchical representation of the objects may be generated using the local transpose embedding coordinates that feed into the object space hierarchical understanding to create topological summaries of hierarchical information. The topological summaries of hierarchical information may provide explanation information (e.g., through generation of new component-connected architectures across subsets of the previous component-connected architecture). The explanation information suggests or explains relationships within the underlying data.

An interactive visualization may be optionally generated to enable selection of data within the topological summaries of hierarchical information and/or statistical interrogation to display explainable information of complex relationships at a simplified lower Dimensional representation. The interactive visualization may, in some embodiments, enable annotation.

Alternatively for additionally, reports may be generated that includes topological summaries of hierarchical information and/or statistical data explaining complex relationships at a simplified lower dimensional representation.

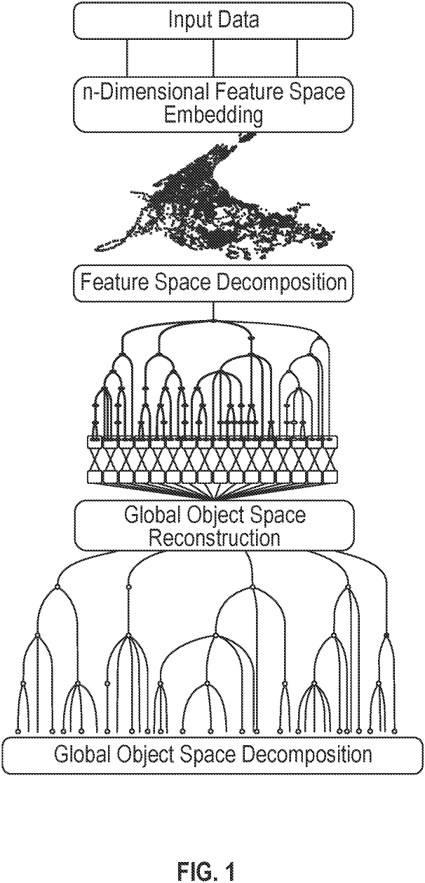

FIG. 1 depicts an overview of construction of a network for explanation generation in some embodiments. In various embodiments, an explainable machine learning system constructs a network (e.g., a deep topological neural network (DTNN)) for automating explainable machine learning methods for data discovery and insight generation. Utilizing topological data analysis and hierarchical processing methods, the explainable machine learning system constructs a component-connected architecture that:
(i) discovers relationships of features in high-dimensional spaces,
(ii) utilizes dimensionality-reduced feature sets to create a local transpose of the isolated features to derive local relationships of the objects within the feature space, and
(iii) formulates a hierarchical representation of the objects using the local transpose embedding coordinates that feed into a complete object space hierarchical understanding.

The explainable machine learning system may create methods for hierarchically structuring information and creating topological summaries of hierarchical information for explanation generation. As discussed herein, the overall process may create components for defining features, feature/object metadata, and object relationships that enable automated processing, statistical interrogation, and/or explainable demonstration of complex relationships at a simplified lower dimensional representation for human evaluation and annotation. In some embodiments, as opposed to competing methods, the explainable machine learning system may establish embedded metafeatures created within the layers of the neural network to contribute to machine learning explainability.

It will be appreciated that the representation may or may not be visualized.

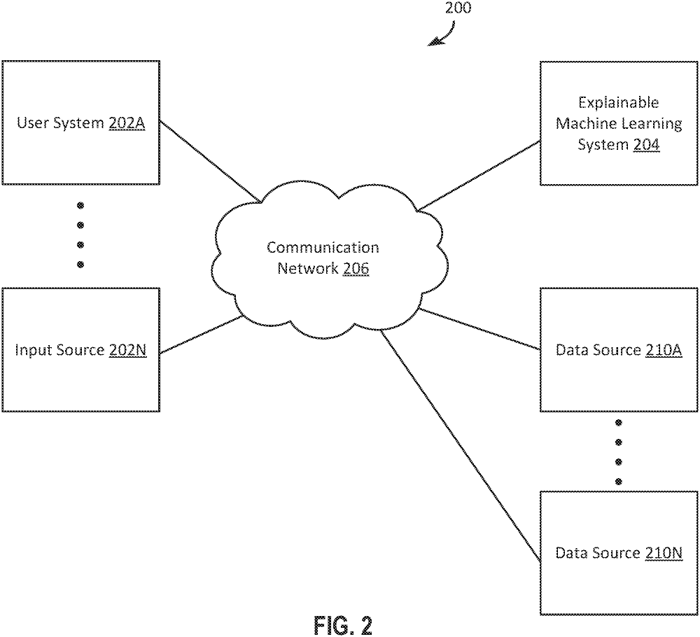

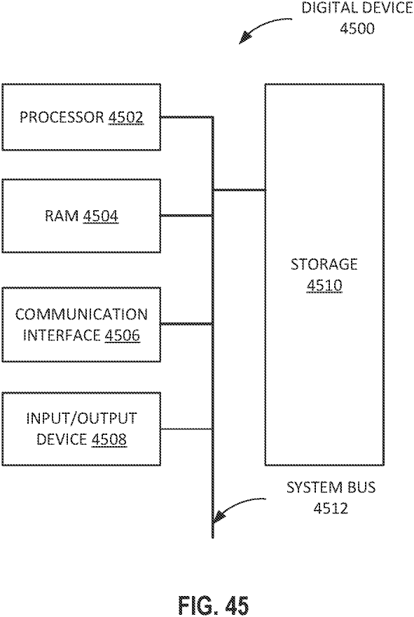

FIG. 2 depicts an example environment 200 for an explainable machine learning system in some embodiments. The example environment 200 includes an explainable machine learning system 204, user systems 202A-N, data sources 210A-N, and a communication network 206. Each of the explainable machine learning system 204, user systems 202A-N, and data sources 210A-N may be or include any number of digital devices. A digital device is any device with at least one processor and memory. Digital devices are further discussed herein, for example, with reference to FIG. 45.

The explainable machine learning system 204 may receive data from any number of data sources for analysis as generally discussed with reference to FIG. 1. The explainable machine learning system 204 may retrieve information, prepare the information for analysis, identify segments of data that preserve and/or highlight significant features, determine features/meta-features for embedding, and identify explainable elements. Explainable machine learning system 204 may further generate a visualization or generate a report to display information and insights. In some embodiments, the visualization may be interactive thereby allowing users to make selections of nodes (centroids) of the generated networks. The interactive visualization is further discussed herein.

One or more of the user systems 202A-N may display interfaces to a user that the user may utilize to control the explainable machine learning system 204. For example, a user of the user system 202A may provide instructions to identify data retained by data sources 210A-N for retrieval, provide metrics/filters, and inspect insights and visualizations from the explainable machine learning system 204.

One or more of the data sources 210A-N may retain information for analysis by the explainable machine learning system 204. In some embodiments, the explainable machine learning system 204 may provide transformed databases, tables, analysis, reports, and/or the like to any number of the data sources 210A-N. In some examples, the data sources 210A-N may include data warehouses, data links, cloud storage, local storage, or any combination thereof.

In some embodiments, the communication network 206 may represent one or more computer networks (for example, LAN, WAN, and/or the like). The communication network 206 may provide communication between any of the explainable machine learning system 204, user systems 202A-N, and/or data sources 210A-N. In some implementations, the communication network 206 comprises computer devices, routers, cables, uses, and/or other network topologies. In some embodiments, the communication network 206 may be wired and/or wireless. In various embodiments, the communication network 206 may comprise the Internet, one or more networks that may be public, private, IP-based, non-IP based, and so forth.

It will be appreciated that any number of unrelated users (e.g., users from different and unrelated enterprises, commercial entities, research institutions, governments, and/or the like) perform analysis on unrelated data sets from any number of data sources by the same explainable machine learning system 204. In some embodiments, explainable machine learning system 204 may provide insights and analysis on a variety of different data sets on behalf of any number of different users.

In various environments, a particular user with privileged data rights to confidential information may provide the information (e.g., encrypted, protected, unprotected, and/or the like) for analysis by the explainable machine learning system 204. The explainable machine learning system 204 may maintain a record of all actions performed on the database, stored any information related to the analysis of the original data within required unprotected data storage, and or authenticate users or devices as required.

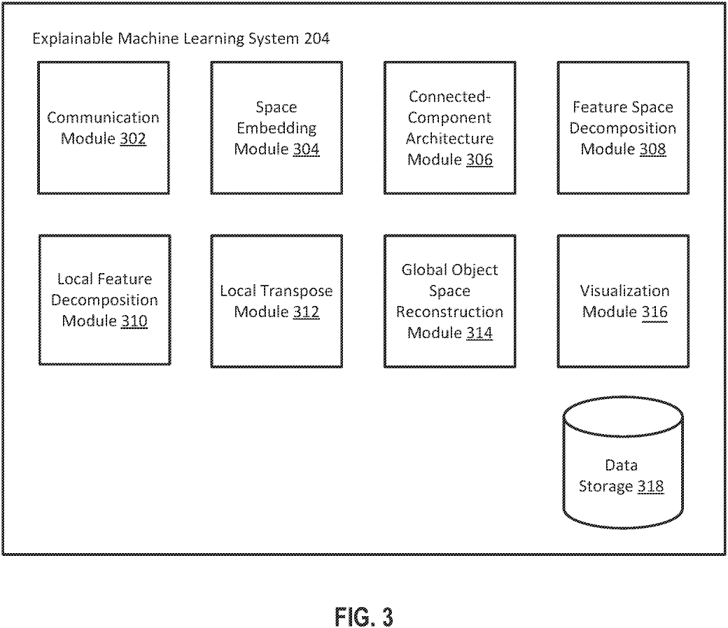

FIG. 3 depicts a block diagram of an explainable machine learning system 204 in some embodiments. The explainable machine learning system 204 comprises a communication module 302, a space embedding module 304, a connected-component network module 306, a feature space decomposition module 308, a local feature decomposition module 310, a local transpose module 312, a global object space reconstruction module 314, a visualization module 316, and a data storage 318.

The communication module 302 may send and/or receive requests and/or data from the data source(s) 110A-110N and/or user devices 102A-N. In one example, the communication module 302 receives data to be analyzed from data source 110A.

The communication module 302 may receive requests and/or data from the user system 106, the input source system 108, and the output destination system 110. The communication module 302 may also send requests and/or data to the user system 106, the input source system 108, and the output destination system 110.

The communication module 302 may receive or provide data or requests to any of the modules of the explainable machine learning system 204. In some buttons, the communication module 302 may receive or provide data to the user devices 102A-N and/or data sources 110AN.

In various embodiments, the communications module 302 receives or retrieves n-dimensional matrix. The n-dimensional matrix may be any data from any number of data sources. In various embodiments, the communications module 302 retrieves data from two or more different data sources 110A-N. The communications module 302 may combine the data from the different data sources to generate the n-dimensional matrix.

The feature space embedding module 304 may generate a lower dimensional embedding feature space by projecting the data based on metrics and/or filters discussed herein.

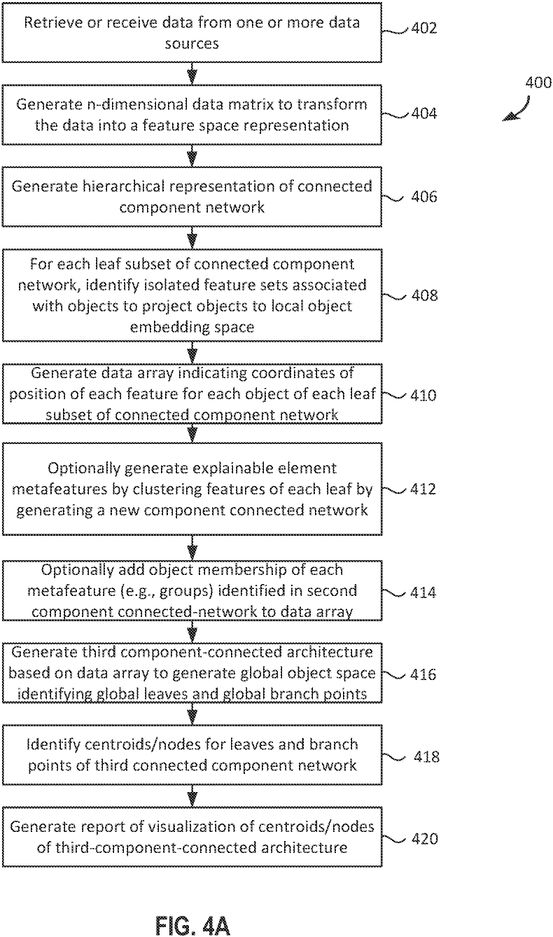

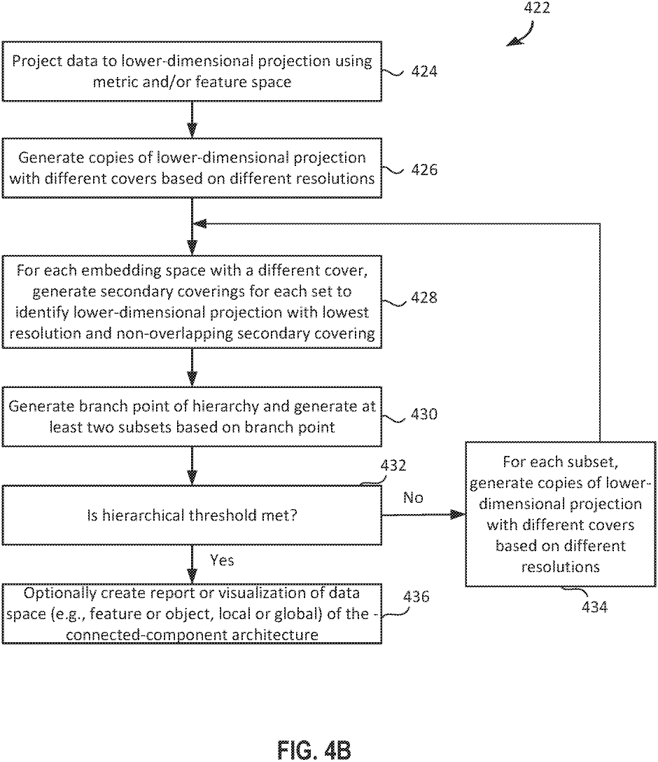

The connected-component network module 306 may generate connected-component networks (e.g., using the “tower of covers” approach discussed herein). The process is discussed with regard to FIG. 4B.

The feature space decomposition module 308 may generate a lower dimensional embedding of the feature space as described herein for each leaf of the first connected-component network as described herein.

The connected-component network module 306 may identify segment (branch) points of the embedded space at different thresholds. The subset of connected components (e.g., derived from the tower covers) may create data subsets for repeating (e.g., nested) above method to produce a hierarchy of local feature sets of common similarity measures. As a result, a recursive hierarchical decomposition (RHD) of the feature space is generated.

In some embodiments, the local features of the RHD group subsets can be visualized back within their reference frame, establishing an explanatory element.

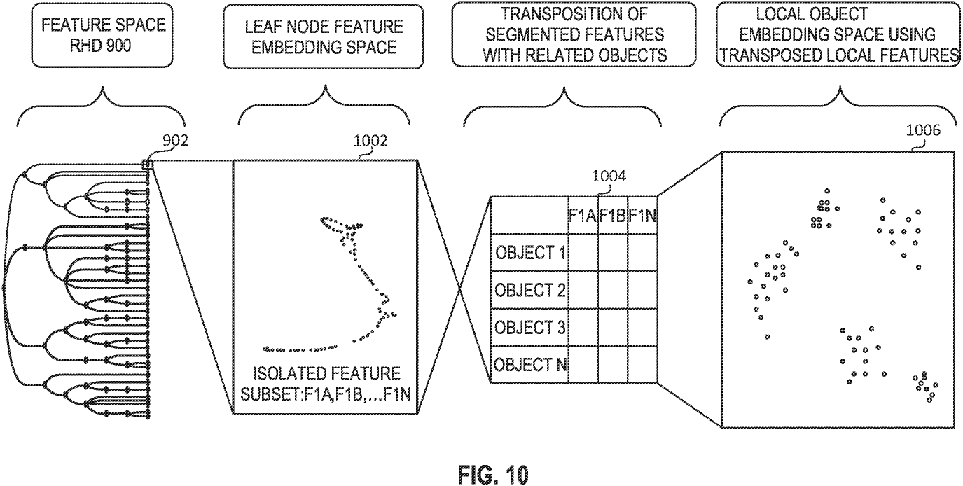

The local feature decomposition module 310 may assist in identifying features in individual leaves of the feature space for embedding in the leaf node feature embedding space or generating the local object embedding space used to transpose local features as discussed with regard to FIG. 10.

The local transpose module 312 is configured to locally transpose the RHD isolated feature sets (e.g., objects as rows and RHD isolated features as columns) as discussed herein.

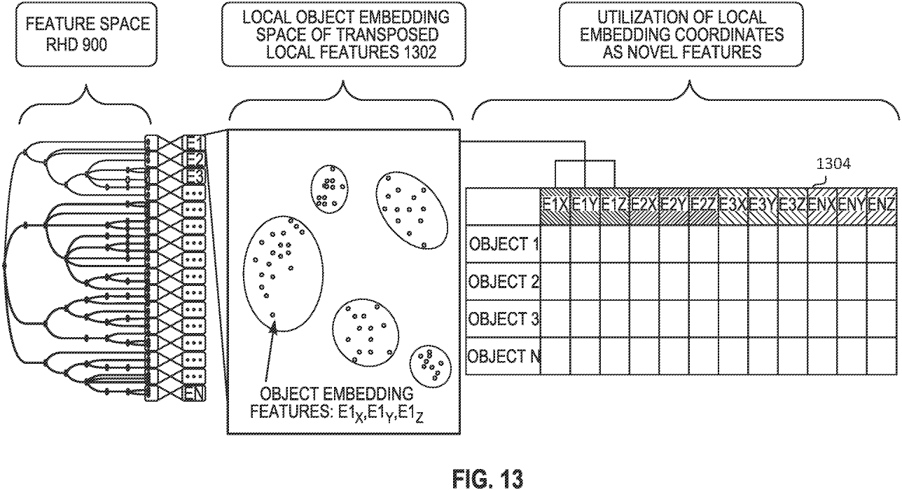

The global object space reconstruction module 314 may generate the global object space, the top node embedding of the global object space RHD 1504, and/or the topological summary of global object space RHD 1902 as described with regard to FIGS. 13-19.

FIG. 3 depicts an example method for explainable analysis in some embodiments. The steps of the method depicted in FIG. 3 will be further described in FIGS. 4-23.

As discussed herein, various embodiments of systems and methods include generation of a component-connected architecture. The component-connected architecture may enable the discovery of relationships of features within high-dimensional spaces.

FIG. 4A depicts a method for generating explainable insights using component-connected architecture(s) in some embodiments.

In step 402, the communication module 302 retrieves or receives data from one or more data sources (e.g., data sources 110A-N). The data may be in any form or organization.

In step 404, the communication module 302 and/or the feature space embedding module 304 may generate an n-dimensional data matrix to transform the data into a feature space representation.

The feature space representation may include features as rows and objects as columns. In various embodiments, the communications module 302 may perform processing on any of the data received from the data sources. For example, the communications module 302 may normalize data, create new features, perform calculations to generate new features, and/or the like. In another example, the communications module 302 may convert data received from one or more data sources into the feature space representation (e.g., features as rows and objects as columns). In some embodiments, the communications module 302 may combine data sets from any number of data sources once each of the data sets are in the feature space representation.

In step 406, the explainable machine learning system tool for may generate a connected-component architecture and a hierarchical representation of the first component-connected architecture based on the feature space representation of the data received from the data sources or user devices. FIG. 4B depicts a method for generating a connected architecture.

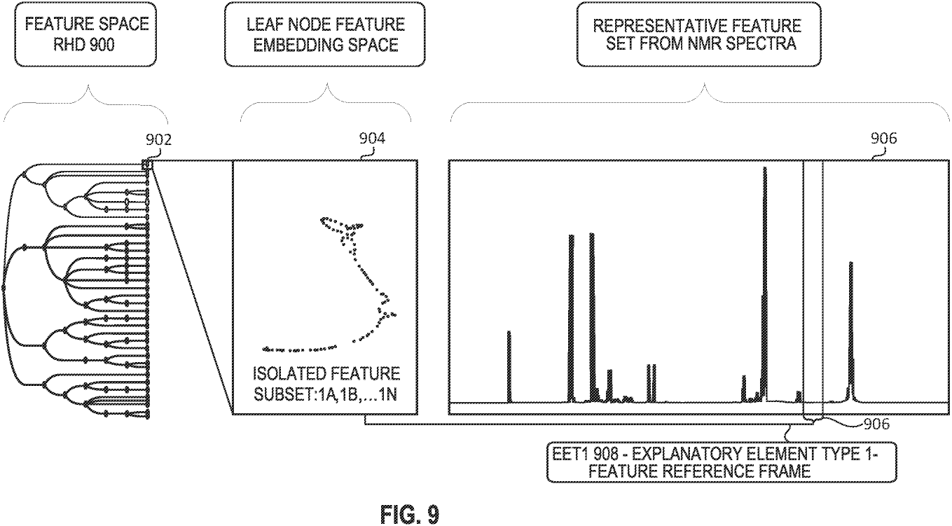

After the first connected-component network is generated based on the feature space representation, in step 408, for each leaf subset of the connected component network, the feature space decomposition module 308 may identify isolated feature sets the social of objects and/or project those objects to a local object embedding space. This process is discussed with regard to FIGS. 9 and 10.

Each leaf (e.g., leaf node) identifies an embedding of the feature space. For example, a leaf node may include an isolated featured subset. The isolated featured subset may be used to generate a transposition of segmented features with related objects. In this example, each row includes the original objects and columns are for each feature of the isolated featured subset for that leaf.

In step 410, the feature space decomposition module 308, the local feature decomposition module 310, or the local transpose module 312 may generate a data array indicating coordinates of a position of each feature for each object of each leaf subset of the connected component network. This process is further discussed with regard to FIGS. 10 and 13.

In step 412, the local transpose module 312 may optionally generate explainable element meta-features by clustering features of each leaf. In one example, a local object embedding space may be generated using the transposition of segmented features with related objects. In one example, metrics and/or filters (e.g., the same metrics and/or filters used to generate one or more other projections) may be used to project the objects into the local object embedding space.

For each leaf node, a coordinate position of an object in its related local object embedding space is identified and included in the data array. The data array includes rows of objects as well as columns identifying coordinates of that object in each local object embedding space of one or more (e.g., all) leaf nodes.

For optional step 412, another component connected architecture using the methodologies described herein may be created for each local object embedding space to identify clusters or groups within the local object embedding space. For example, different coverings can be applied to one or more embedding spaces to identify nonoverlapping secondary coverings (e.g., using the methods described herein). The nonoverlapping secondary coverings identify subset branch points and two or more subsets within the embedding space may be similarly assessed (e.g., for each subset from the branch point, different covers can be applied to identify nonoverlapping secondary coverings to further identify branch points for further analysis) until a threshold is reached. The threshold may be any limiting determination of function including, for example, a number of subsets found, a statistical measure based on the original data set, a number of groups based on the data within the local object embedding space, and/or the like.

In this optional example, an object may be a member of a group which may be termed as a meta-feature.

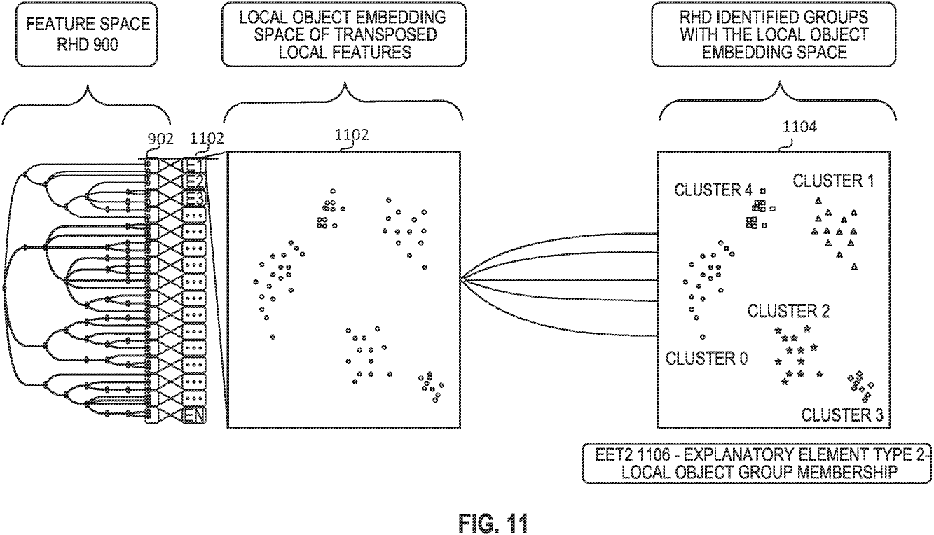

In step 414, each meta-feature may be uniquely identified (e.g., MF1-N) for each local space and membership of that meta-feature group for each object across all local embedding spaces may be added to the data array (e.g., the same data array that contains object coordinates across the leaves of the first connected-component network). This process is further described with reference to FIGS. 11-14.

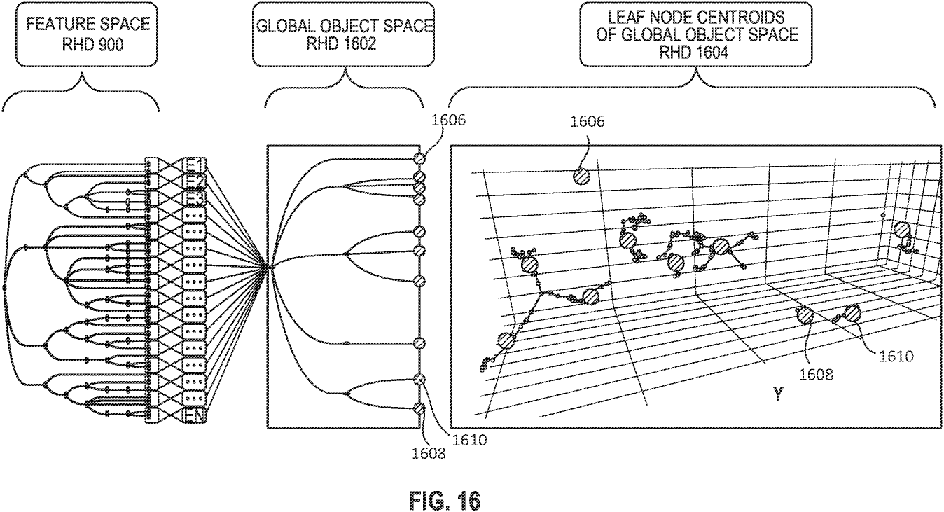

In step 416, the connected-component network module 306 may generate a third connected-component network based on the data array from step 410 or steps 410-414 (e.g., including or not including the metafeatures described herein) to generate a global object space that includes global leaves and global branch points. This process is similar to that described with regard to FIG. 4B but utilizes the data array. This process is further described with reference to FIG. 16.

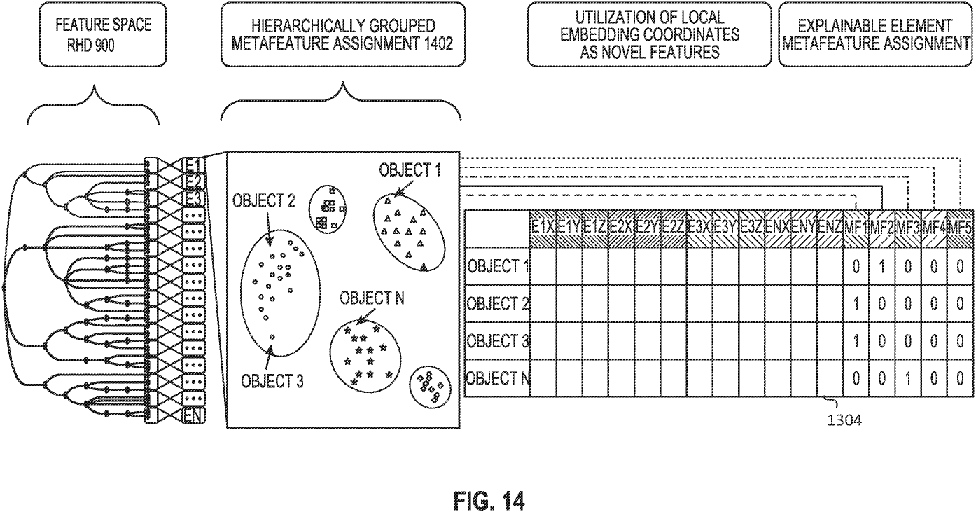

In step 418, the global object space reconstruction module 314 identifies centroids (i.e., nodes) for leaves and branch points of the third connected-component network. This process is further described with regard to FIGS. 14-20.

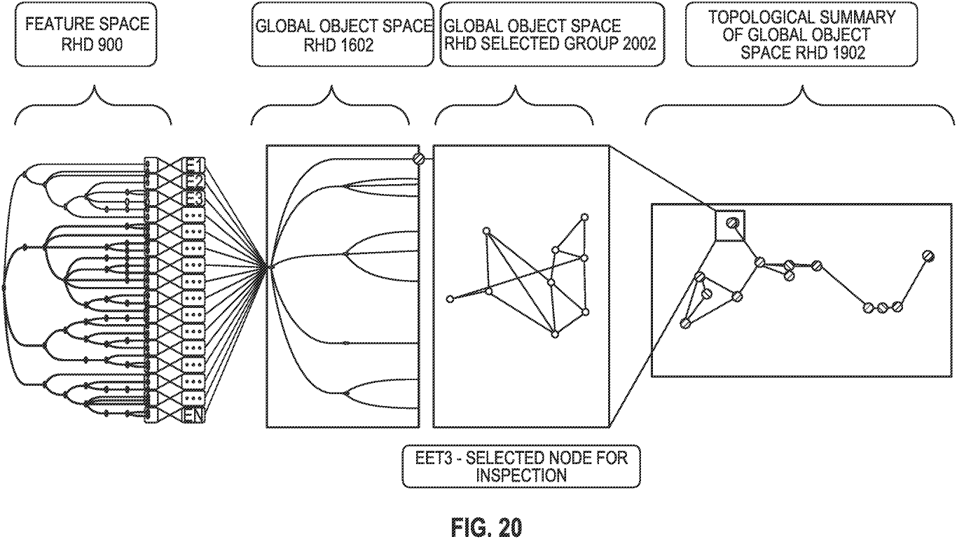

In step 420, the visualization module 316 may generate a report or visualization of the centroids (e.g., nodes) of the third connected-component network (e.g., as depicted in FIG. 20). In some embodiments, the visualization module 316 may generate an interactive visualization interactive visualization to enable selection of data within the topological summaries of hierarchical information and/or statistical interrogation to display explainable information of complex relationships at a simplified lower Dimensional representation. The interactive visualization may, in some embodiments, enable annotation.

Alternatively, for additionally, reports may be generated that includes topological summaries of hierarchical information and/or statistical data explaining complex relationships at a simplified lower dimensional representation.

FIG. 4B depicts a method for generating component-connected networks in some embodiments. It will be appreciated that this process may be titled a “tower of covers” approach to network generation.

In step 424, the space embedding module 304 may project data from the received data (e.g., from the feature space representation or data array discussed herein) into an embedding space. The space embedding module 304 may project the data using any number of ways. For example, the space embedding module 304 may utilize one or more metrics and/or filters (e.g., receipt from the user device) to make the projection.

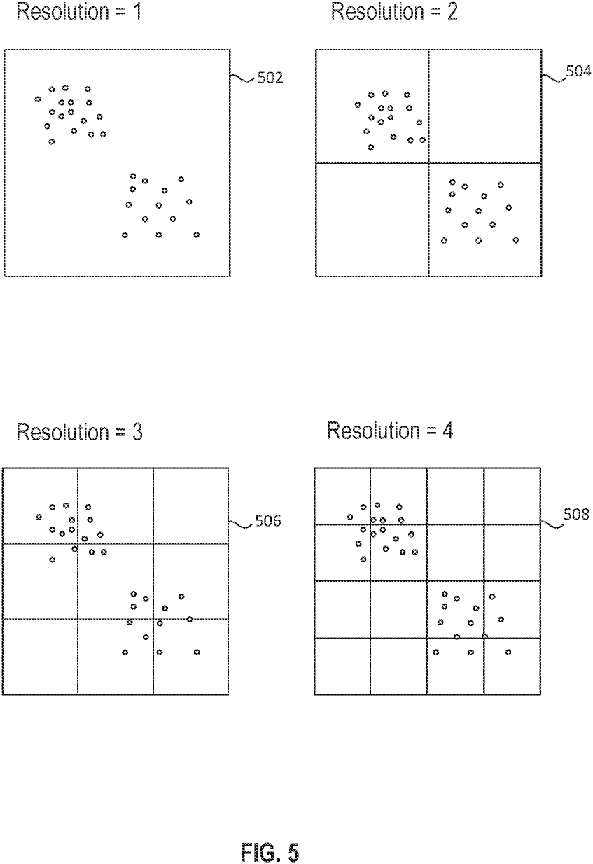

The connected-component network module 306 may perform steps 426 through 444 to generate the connected-component network. In step 426, the connected-component network module 306 may apply different covers of the embedding space to identify nonoverlapping secondary coverings for branch identification. The connected-component network module 306 may generate sequentially apply each different covering to the embedding space and/or generate copies of the embedding space and apply a different covering to each of the embedding spaces. FIG. 5 includes an example of the different coverings applied to the same embedding space (e.g., the projection of the data generated in step 424).

It will be appreciated that each cover may create one or more sets (e.g., individual squares covering the embedding space as depicted in FIG. 5).

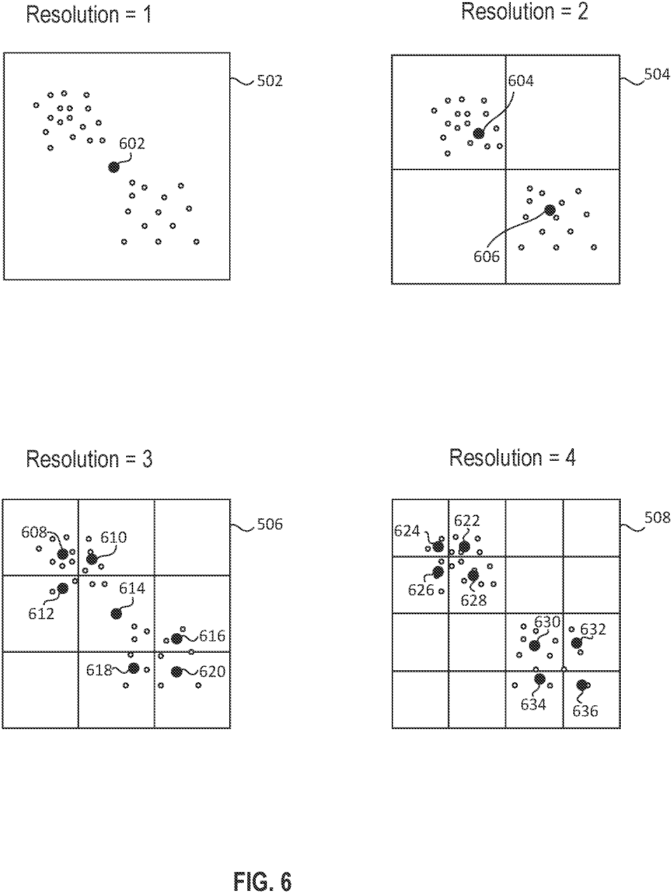

In step 428, for each embedding space with a different cover, the connected-component network module 306 generates secondary coverings for each set to identify the lower dimensional projection with the lowest resolution and nonoverlapping secondary coverings. In one example, a centroid is determined for each set within the covering. The centroid is determined based on the data within that set as discussed herein. This process is discussed with regard to FIG. 6.

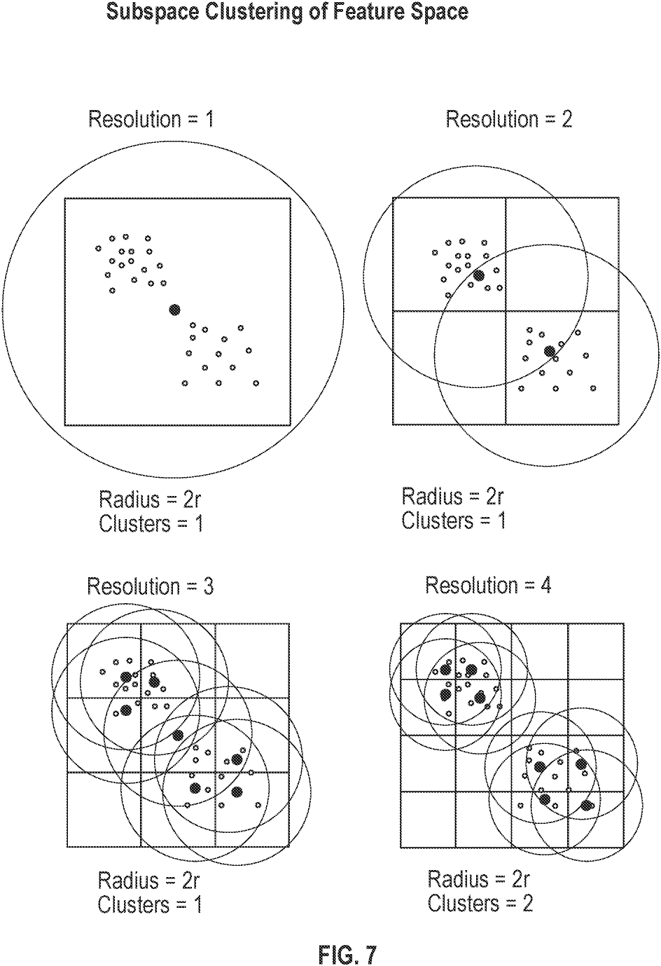

Brief centroid secondary coverings generated using the centroid at the center of the secondary covering. The secondary covering covers the particular set of data points. The connected-component network module 306 determines if there is overlap between the two secondary coverings (e.g., if there are separate clusters). A branch point is identified based on the embedding space with the lowest resolution that has at least two data sets with nonoverlapping secondary covers. This process is further discussed with regard to FIG. 7.

In some embodiments, to generate the first component-connected architecture, dimensionality-reduced feature sets are used to create a local transpose of the isolated features to derive local relationships of the objects within the feature space. A hierarchical representation of the objects may be generated using a local transpose embedding coordinates that feed into the object space hierarchical understanding to create topological summaries of hierarchical information. The topological summaries of hierarchical information may provide explanation information. The explanation information suggests or explains relationships within the underlying data.

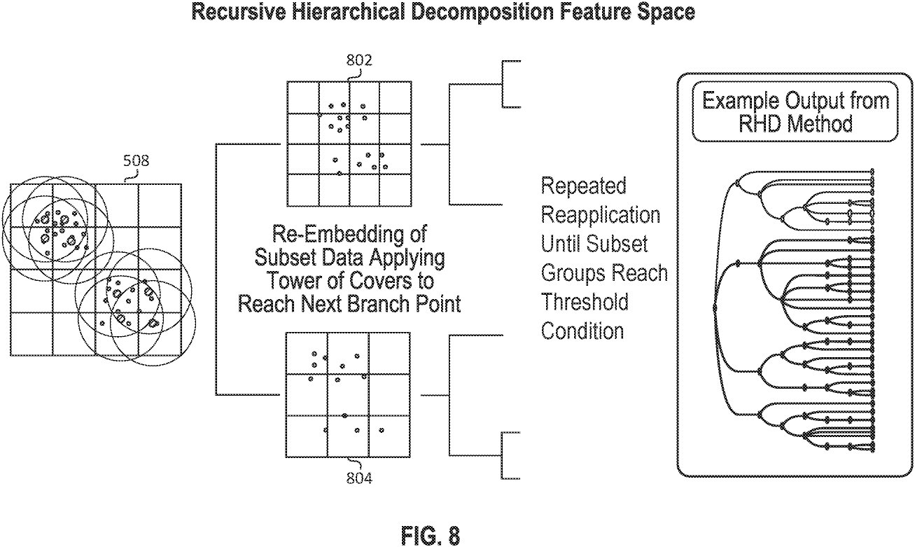

In step 430, the connected-component network module 306 generates a branch point of the hierarchy based on the projection with the lowest resolution and nonoverlapping secondary covering. The connected-component network module 306 generates at least two subsets based on the branch point. This process is further discussed with regard to FIG. 8.

In step 432, the connected-component network module 306 determines if a hierarchical threshold is met to terminate the network generation process. It will be appreciated that there may be any number of thresholds to generate the network generation process as discussed herein. The network will continue to be generated with additional branch points and subsets until the hierarchical threshold is met.

If the hierarchical threshold is not met, the method continues to step 434. In step 434, in a manner similar to that of step 426, for each subset of the branch, the connected-component network module 306 applies different covers to each subset to identify the lowest resolution with nonoverlapping secondary coverings. The method continues to step 428 as applied to each subset from the branch point.

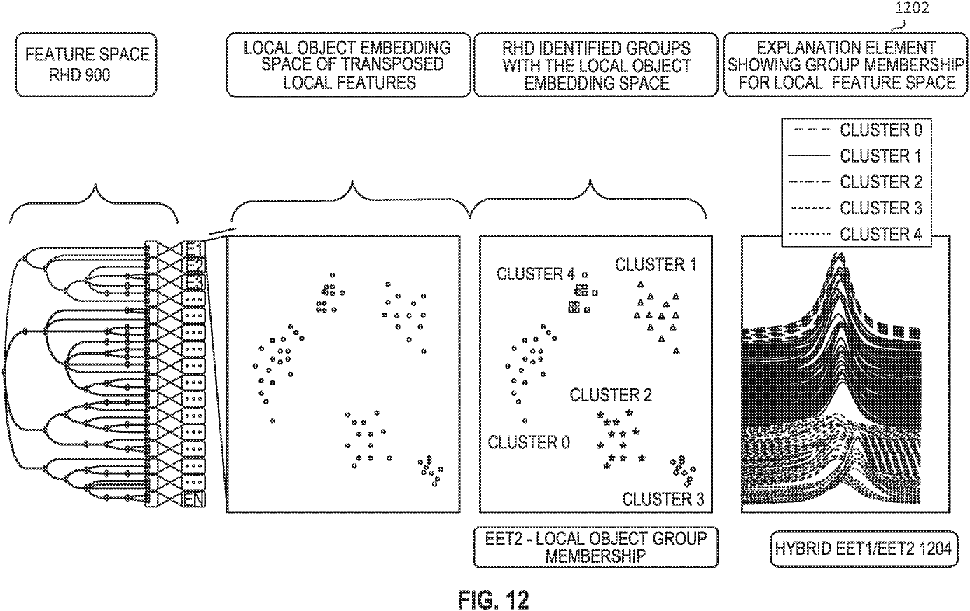

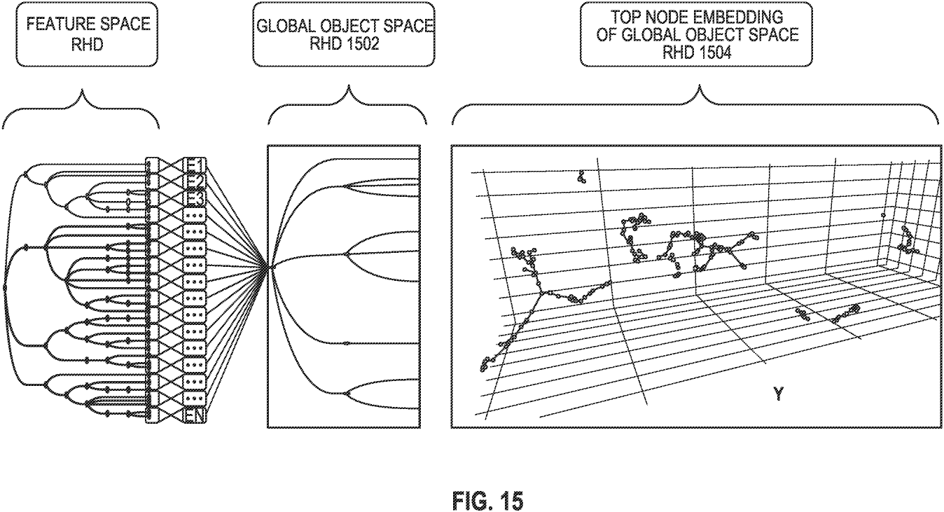

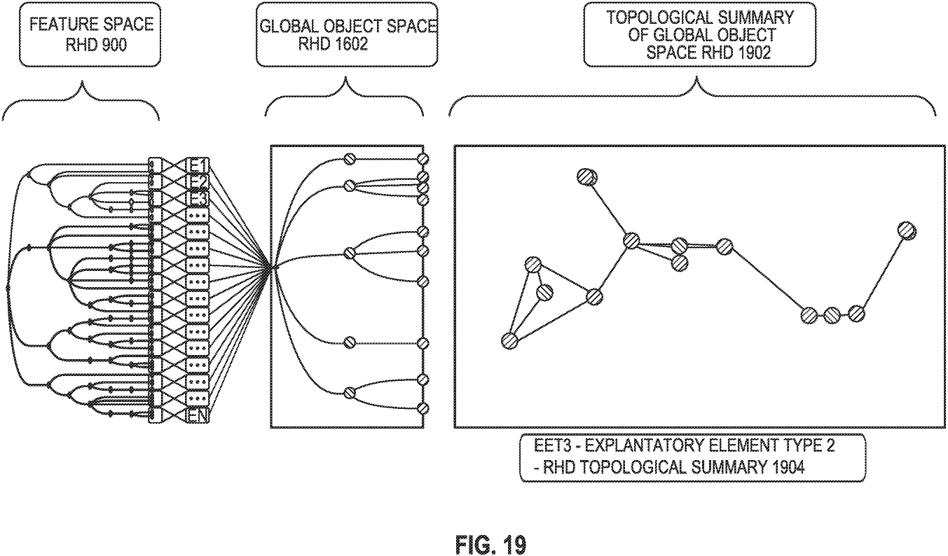

If the hierarchical threshold is met, then the method continues to step 436. In step 436, the connected-component network module 306 and/or the visualization module 316 may optionally generate a report visualization of the resulting data space (e.g., feature or object, local or global) of a connected-component architecture (e.g., the feature space RHD 900 of FIG. 9, the leaf node feature embedding space 1002, explanation element showing group membership from local feature space 1202 in FIG. 12, the top note embedding global object space RHD 1504 in FIG. 15, the global object space RHD 1502 in FIG. 15, the topological summary of global object space RHD 1902 in FIG. 19, and/or the like).

FIG. 5 depicts an initial approximation of the recursive hierarchical decomposition (RHD) of the dataset in some embodiments. Although the term “recursive” is used with respect to the RHD, it will be appreciated that a series of covers may be applied to the same data projection (e.g., the same embedding space) to identify non-overlapping secondary coverings. The process may not be recursive in other aspects as will be shown herein.

In FIG. 5, the initial approximation of the RHD begins through transformation of a high-dimensional data space into a lower dimension projection using any generic dimensionality reduction method combining metric and filter spaces (e.g., Euclidean, cosine, correlation, t-sne, umap, mds, pca, or the like). In one example, the feature space embedding module 304 utilizes a metric and/or filter functions (e.g., spaces) to transform high dimensional data received from the data source into a lower dimensional projection.

Following embedding, the feature space decomposition module 308 may apply a uniform (or non-uniform) cover to the embedding. FIG. 5 depicts a variety of different uniform covers at different resolutions that cover the same data space. Graph 502 depicts a cover (e.g., a square) with a resolution of one that covers the projected data points. Graph 504 depicts a cover of a resolution of 2 (e.g., 2² or 4 uniform squares or sets) covering the data space. Graph 506 depicts a cover of a resolution of 3 (e.g., 3² or 9 uniform squares or sets) covering the data space. Graph 508 depicts a cover of a resolution of 3 (e.g., 4² or 16 uniform squares or sets) covering the data space.

It will be appreciated that a single data space utilizing covers of a specific resolution can be utilized in conjunction with systems of methods discussed herein. Ultimately, in some embodiments, any number of different resolutions may be utilized. Although FIG. 5 depicts square sets, it will be appreciated that the sets of the coverings may be of any shape or combination of shapes (e.g., different intervals and/or sizes).

For 2- and 3- component embeddings, a uniform embedding can be applied as squares, rectangles, or voxels where resolution is defined by the maximum and minimum components in their respective projection space. It is not necessary to preserve any relationship between individual component resolution values and they can be treated as independent parameters. For ease, FIG. 5 depicts the embedded data covered by a uniform square cover at multiple resolutions, although it will be appreciated that any cover at any resolution may be utilized.

The cover will assist with the clustering of the feature space for recursive hierarchical decomposition. FIG. 6 depicts a tower of covers utilizing stepwise resolution increases in some embodiments. The covering of the data includes a subset or plurality of subsets of the data used to compute a centroid of the component values. The centroid may be calculated in any number of ways. In one example, a centroid is calculated based on an average of the data within the individual set of the cover.

In graph 502 of FIG. 6, the centroid is at the center of the data space. In this example, the centroid is represented as point 602 and is calculated based on the data points mapped to the data space (e.g., the metric space). In graph 504 of FIG. 6, for the cover has a resolution of 2, the centroid is calculated based on the data within the individual set (e.g., the individual portion of the cover). In this example, there are two individual sets that are empty (i.e., devoid of mapped data points), and as a result, do not have a centroid. Centroid 604 and centroid 606 are based on the data points contained in their particular sets, respectively. For example, centroid 604 is based on data points contained within its particular set (i.e., the square) but not the data points in any other set of the same space. Similarly, centroid 606 is based on data points contained within its particular set (i.e., the square) but not the data points in any other set.

In graph 506, the data space is divided into nine sets (e.g., graph 506 has a resolution of three). Two of the nine sets have no data points mapped to those individual spaces and therefore have no centroids. Centroids 608, 610, 612, 614, 616, 618, and 620 are each based on the data points within their respective sets.

In graph 508, the data space is divided into 16 sets (e.g., graph 508 has a resolution of four). Eight of the 16 coverings have no data points mapped to those individual spaces and therefore have no centroids. Centroids 622, 624, 626, 628, 630, 632, 634, and 636 are each based on the data points within the respective sets.

FIG. 7 depicts subspace clustering of feature space in some embodiments. Branch points for the non-overlapping connected neighborhood graphs may be identified based on identification of non-overlapping connected neighborhood graphs at the lowest resolution.

In various embodiments, following centroid determination, a circle with a radius of fixed length is centered on each centroid creating a secondary covering. The radius may, for example, be the distance from the centroid to cover the set (e.g., a corner of that set as depicted). Each circle can be parameterized to include a single radius, or a plurality of radii, of differing lengths that scale proportionally to the resolution size.

In FIG. 7, each data space (e.g., graph 502, 504, 506, and 508) is covered by a secondary covering defined by a radius with the respective centroid as the center.

In other words, FIG. 7 demonstrates covering of the embedded space over 4 resolutions. At resolution=1,2, and 3, non-empty sets result in a single connected component due to a minimum of one centroid being common to a fully connected intersection. At resolution=4, two non-overlapping connected neighborhood graphs (e.g., there are two non-overlapping secondary coverings) are created resulting in a branch point within the topological hierarchy.

Graph 502 in FIG. 7 depicts a single secondary covering that covers the entire embedded space. The secondary covering is based on a radius from the centroid 602 and extends across the covering (which in this case, there is a resolution of one, includes the entire embedded space). As a result, a single cluster (i.e., a cluster=1) is identified.

Graph 504, which has a resolution of two, includes two secondary coverings based on the two centroids 604 and 606, respectively. Since these secondary coverings overlap, a branch point is not identified. Like graph 502, graph 504 has a single cluster (i.e., a cluster=1).

Graph 506 has a resolution of three. As discussed herein, each centroid (e.g., centroid 608, 610, 612, 614, 616, 618, and 620) is the center of its own respective secondary covering. Since these secondary coverings overlap, a branch point is not identified. Like graphs 502 and 504, graph 506 has a single cluster (i.e., a cluster=1).

Graph 508 has a resolution of four. Each centroid (e.g., centroids 622, 624, 626, 628, 630, 632, 634, and 636) is the center of its own respective secondary covering. Here, there are at least two secondary coverings that do not overlap and a branch point is identified. In this example, there are two clusters (i.e., clusters=2).

FIG. 8 depicts a recursive hierarchical decomposition (e.g., a first connected-component network) of the feature space in some embodiments. At each branch point, two or more distinct subsets of the embedded data are created. Each subset is individually re-embedded utilizing a common metric/filter combination. The tower of covers approach may be again deployed (e.g., applying covers of increasing resolutions as show in FIGS. 5 and 6) upon the subset embedding until an additional branch point is detected. The process is repeatedly applied until the terminal subsets of data meet a threshold. Examples of thresholds can be minimum group size, entropy or variance of the resulting subset, or other methodology that creates a terminal stopping point.

FIG. 8 depicts graph 508 with two distinct subsets of the embedded data 802 and 804. Each subset is individually re-embedded utilizing a metric, filter, or a combination of a metric and a filter.

The process repeats itself to identify new branch points for each distinct subset. In this example, the process discussed with respect to FIGS. 4A, 4B, 5-7 repeats for each distinct subset of embedded data until a new branch point is identified and new distinct subsets are created. The process can repeat again until the threshold is reached.

For example, for each of the subsets of embedded data (e.g.., embedded data 802 and 804), a range of resolutions may be used to divide the embedded data space into individual sets, centroids may be determined for sets that contain data points, secondary coverings may be identified based on the centroids, and branch points determined based on non-overlapping secondary coverings to create at subsets of embedded data. The process can continue when that particular subset of embedded data is again divided into sub-subsets of embedded data and the process can continue.

FIG. 8 further depicts an example output from the RHD method showing the branch points, and process of re-embedding of subset data and applying the “tower of covers” approach to reach the next branch point.

FIG. 9 depicts a reference frame context in some embodiments. Within the initial layer of the deep topological neural network (DTNN), highly similar features are discovered across the objects. These features relate back to a reference frame with which the features are defined. FIG. 9 depicts how a set of intensity measurements of an NMR spectra can be visualized within the total NMR spectral reference frame deriving an Explanatory Element Type 1 (EET1 908).

FIG. 9 depicts a first leaf 902 (e.g., a lowest subset of any number of elements) derived from the process of the tower of covers discussed herein) of the feature space RHD 900 (e.g., the first connected-component network). The first leaf feature embedding space 904 depicts the embedded space that corresponds to the first leaf 902. The first leaf feature embedding space 904 includes isolated feature subsets 1A-1N. In this example, the EET1 908 is a section of the spectra that corresponds to the feature subset of the first leaf 902 (e.g., the terminal subset at the lowest level).

FIG. 10 depicts a second layer of the network (e.g., DTNN) in some embodiments. The isolated feature sets of high similarity (defined through a RHD using any general metric/filter combination) can be locally transposed to create a data array of objects.

In FIG. 10, similar to FIG. 9, the feature space RHD 900 includes first leaf 902. The leaf node feature embedding space 1002 depicts isolated features subsets F1A-F1N of that first leaf 902. The local transpose module 312 transposes the segment features of the leaf node feature embedding space with related objects. A sample table 1004 depicting objects 1-N as rows and isolated features F1A-F1N as columns is depicted in FIG. 10. The local object embedding space using transposed local features is depicted in graph 1006.

Here, the isolated features become the columns and the objects become the rows. A subsequent embedding of the data array illustrates distinct groupings and embedding positions. The local object space is distinct in that it can create a highly localized similarity estimation of the local features (e.g., the local features only).

FIG. 11 depicts the optional creation of metafeatures to explain segmentation in some embodiments. FIG. 11 depicts the feature space RHD 900 and leaves (e.g., leaf 902) as well as the local object embedding space of transposed local features for each leaf (e.g., leaf 902 corresponds to the local object embedding space of transposed local features 1102 for that particular leaf).

In addition to embedding coordinates, the local object embedding space may be further processed to create metafeatures that explain and describe segmentation, anomaly/outlier, and/or local hierarchy of the embedding distributions. Here, the RHD method described herein is utilized to identify unique groups within the local object space embedding (e.g., the RHD identified groups with the local object embedding space 1104). The RHD identified groups with the local object embedding space 1104 includes clusters 0-4 (e.g., the EET2 1106, which is the explanatory element type 2, local object group membership).

FIG. 12 depicts the explanation element showing group membership for a local feature space in some embodiments. FIG. 12 includes elements from FIG. 11, including the feature space RHD 900 and leaves (e.g., leaf 902), the local object embedding space of transposed local features for each leaf, as well as the RHD identified groups with the local object embedding space 1104 includes clusters 0-4 (e.g., the EET2 1106 which is the explanatory element type 2, local object group membership). FIG. 12 further depicts the explanation element showing group membership for the local feature space 1202. The line graph in FIG. 12 depicts line graphs for hybrid EET1/EET2 1204.

FIG. 13 depicts the utilization of local embedding coordinates as novel features across the local transposed elements in some embodiments. The local object space embedding components further establish features for feed-forward network propagation. Embedding coordinates (e.g., x, y, and z coordinates) of each feature of the local object embedding space of transposed local features 1302 are utilized across the local transposed elements to create a new data array unifies the object space understanding. In the example of FIG. 13, the embedding features are shown for the three components of the embedding. Feed-forward embedding features can include any number of individual components from any metric/filter similarity understanding.

The local object embedding space of transposed local features 1302 includes groups of object embedding features Elₓ, E1_{y}, and E1z (the coordinates of E1).

Although coordinates x, y, and z are shown by example in FIG. 13, it will be appreciated that any coordinate system may be used. Similarly, although a three-coordinate system is depicted in FIG. 13, any number of dimensions may be used for coordinates to be included in the local transposed elements to create a new data array for unification of the object space understanding.

The table 1304 depicts the rows of objects 1-N with additional features (e.g., columns) including the coordinates of each feature for that related objects.

FIG. 14 depicts local clustering group information that is encoded as membership to hierarchically defined groups in some embodiments. FIG. 14 depicts local clustering group information that is encoded as membership to hierarchically defined groups in some embodiments. Graph 1402 depicts groups (i.e., hierarchically groups) that are hierarchically grouped metafeatures. In this example, graph 1402 includes grouped circular items that are associated as MF1, root triangular objects associated as MF2, grouped star objects associated as MF3 grouped diamond-shaped objects associated as MF4, and grouped square items that are associated as MF5. Explainable element metafeatures (e.g., MF1-5) are then added to table 1304 which depicts the rows of objects 1-N with additional features (e.g., columns) including the coordinates of each feature and explainable element metafeatures.

Insights and explainable elements can be further appended to the data array (e.g., table 1304) that captures embedding features for feed-forward modeling. FIG. 14 depicts that clustering group information is encoded as membership to the hierarchically defined groups (MF1, MF2, MF3). In addition, overall membership of the locally transposed group metafeatures can be annotated.

FIG. 15 depicts creation of an RHD summary in some embodiments. The summary of the RHD process can be created at the top-node embedding level of the RHD 1504 (e.g., the top node embedding of global object space RHD 1504). In some embodiments, a maximal spanning tree is created from the individual leaf-nodes of the global object space RHD. The distances and connectivity of the maximal spanning tree may be subsequently applied to the individual objects within the top-node embedding deriving distinct class understanding.

In various embodiments, the explainable machine learning system 204 may generate a visualization. A visualization may include a graph, report, interactive display, or the like depicting one or more leaf and/or subset centroids determined by methods described herein.

In FIG. 15, for example, the top node embedding of global object space RHD 1504 may be expected in a visualization as shown in the figure. In various embodiments, the visualization may show the feature space RHD 900, the global object space RHD 1502, and/or are the top node embedding global object space RHD 1504.

Some embodiments described herein permit manipulation of the data from the visualization. For example, portions of the data which are deemed to be interesting from the visualization can be selected and converted into database objects, which can then be further analyzed. Some embodiments described herein permit the location of data points of interest within the visualization, so that the connection between a given visualization and the information the visualization represents may be readily understood.

FIG. 16 depicts leaf node centroids of global object space RHD 1604 in some embodiments. For each fully connected leaf node group, the subset of data can be represented by placing a centroid at the relevant position. Centroids in the global object space RHD 1604 are depicted as large or circular objects, such as centroids 1606, 1608, and 1610 (as associated with centroids of the global object space RHD 1602).

The centroid may be calculated in a manner described by other centroids herein or in any number of ways. Size of the node (e.g., that represents the centroid) may, in some embodiments, may represent group size of the subset (not shown here).

In some embodiments, the global object space RHD 1602 (e.g., including the leaf centroids) and/or leaf node centroids of global object space RHD 1604 may be depicted in the visualization.

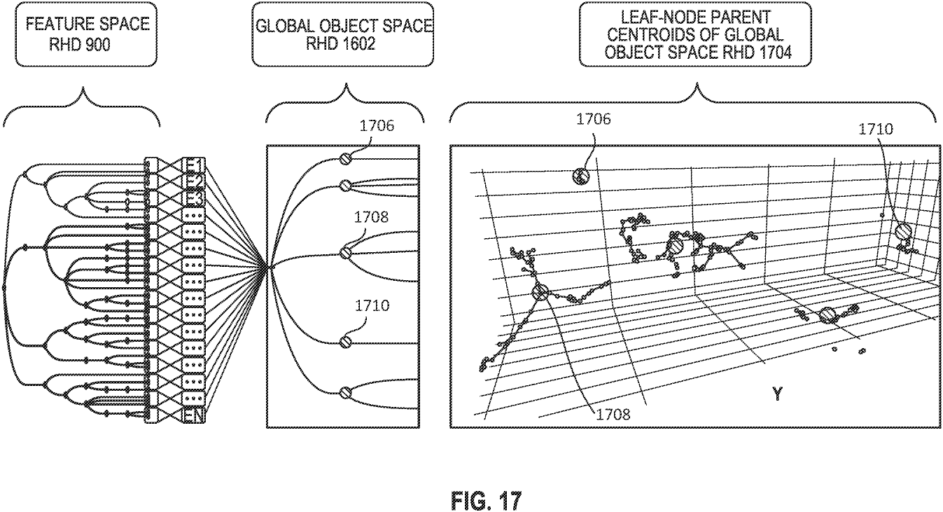

FIG. 17 depicts subset node centroids of global object space RHD 1704 in some embodiments. Working up the RHD, a centroid can be overlaid within the embedding space that approximates the relevant centroid position for each subset of data contained within the local branch. Centroids in the global object space RHD 1704 (which may correspond to the global object space RHD 1604) are depicted as large or circular objects, such as centroids 1706, 1708, and 1710 (as associated with centroids of the global object space RHD 1602).

Similar to the centroids depicted in FIG. 16, the centroids may be calculated in a manner described by other centroids herein or in any number of ways. Size of the node (e.g., that represents the centroid) may, in some embodiments, may represent group size of the subset.

In some embodiments, the global object space RHD 1602 (e.g., including the subset centroids) and/or subset node centroids of global object space RHD 1704 may be depicted in the visualization. In various embodiments, both the leaf node centroids depicted in the global object space RHD 1602 and the subset node centroids depicted in the global object space RHD 1704 may be depicted in the visualization.

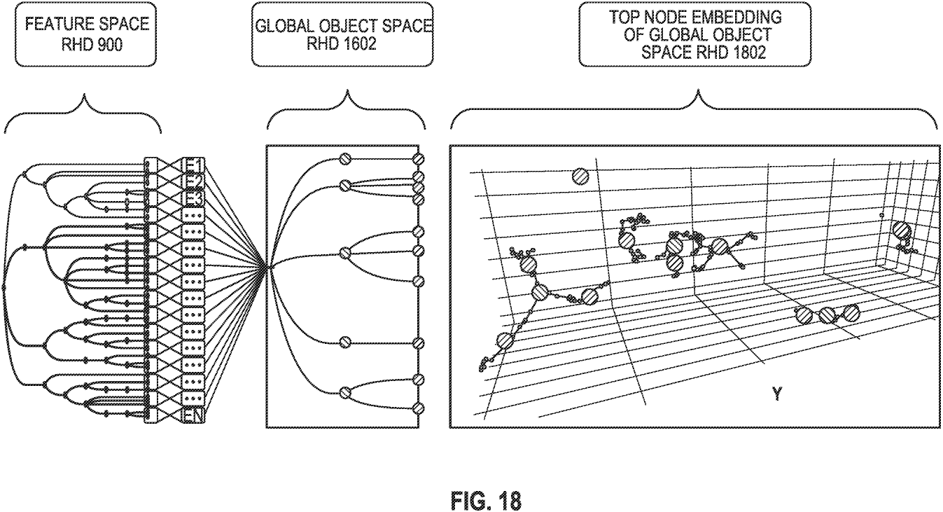

FIG. 18 depicts leaf and subset centroid placements within the embedding for each layer of the RHD in some embodiments. In FIG. 18, leaf and subset centroids are differentiated by illustrated texture (lines in different directions) and depicted in the global object space RHD 1604.

In some embodiments, the global object space RHD 1602 (e.g., including the subset centroids and leaf centroids) and/or centroids of the top node embedding of global object space RHD 1802 may be depicted in the visualization.

FIG. 19 depicts a topological summary of global object space RHD 1902 in some embodiments. The topological hierarchical decomposition shows a topological summary illustrating fully connected graph network. In this example, individual branches of the RHD summary are connected via their nearest distance of the underlying leaf nodes.

In some embodiments, the topological summary is complete when all underlying leaf node centroids are connected. Leaf nodes of the same branch node may be connected to each other and the first branch node to which it belongs. In various embodiments, leaf nodes may be connected based on a comparison of a distance metric between two or more objects or centroids of a different leaf node.

In some embodiments, the global object space RHD 1602 (e.g., including the subset centroids and leaf centroids) and/or centroids of the topological summary of global object space RHD 1902 may be depicted in the visualization.

FIG. 20 depicts an interactive visualization of the topological summary in some embodiments. In various embodiments, the topological summary can be interactively inspected. In some embodiments, Selection of a node from the summary can call the associated global object space leaf node.

The interactive visualization allows the user to observe and explore relationships in the data. In various embodiments, the interactive visualization allows the user to select nodes from the visualization. The user may then access the underlying data of the selected node (e.g., the centroid) and/or perform further analysis (e.g., statistical analysis) on the underlying data or on data as grouped within the global object space (e.g., global object space RHD selected group 2002).

In various embodiments, the user may interact with the interactive visualization depicting the topological summary of global object space RHD 1902 by selecting a centroid. In response to the selection, the interactive visualization may display the global object space RHD selected group 2002 which includes the subset of data identified by the methods discussed herein (e.g., the data for the selected centroid associated with the similar centroid of the global object space RHD 1602). It will be appreciated that the user may select any number of centroids to obtain additional diagrams graphs with the like. In various embodiments the user may be able to select one or more points or edges depicted in the global object space RHD selected group (e.g., global object space RHD select group 2002) to access the underlying data (e.g., the data from the underlying tables).

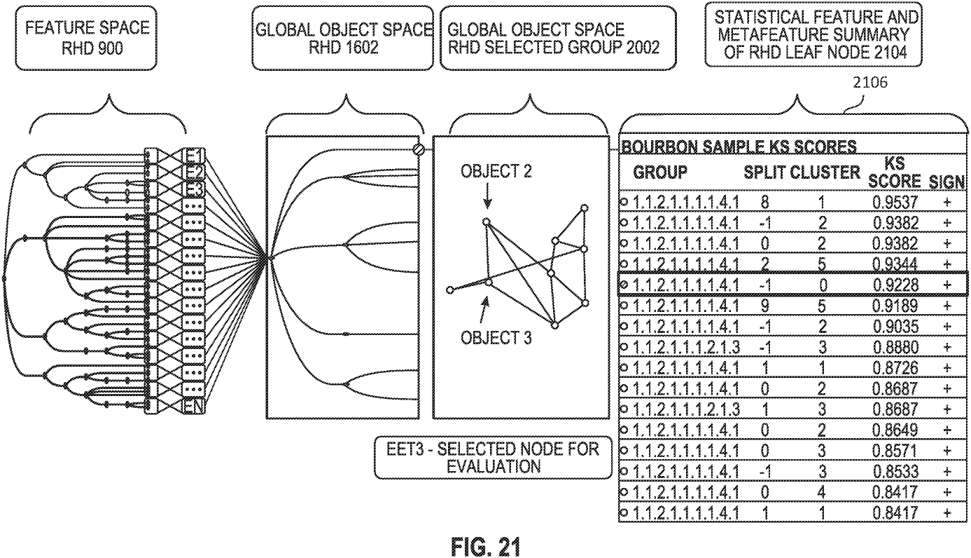

FIG. 21 depicts a statistical feature and metafeature summary of the RHD leaf node in some embodiments. The object space RHD may autonomously subset the data into individual groups through the recursive RHD process. The group subset at each node within the RHD can be statistically analyzed to understand unique features that induce segmentation. Object 2 and 3, which shared a common metafeature group assignment from a local object space model also segment together within the global object space RHD 1602. The group as a whole can be analyzed statistically to identify unique features of the RHD isolated group (e.g., within the statistical feature and metafeature summary of RHD leaf node 2104).

In the interactive visualization, a user may make a selection within the interactive visualization to depict the statistical feature and metafeature summary of RHD leaf node 2104 (e.g., table of visualization 2106). In this example, the statistical analysis includes bourbon sample KS scores. The specific feature space group can be selected for explanation visualization.

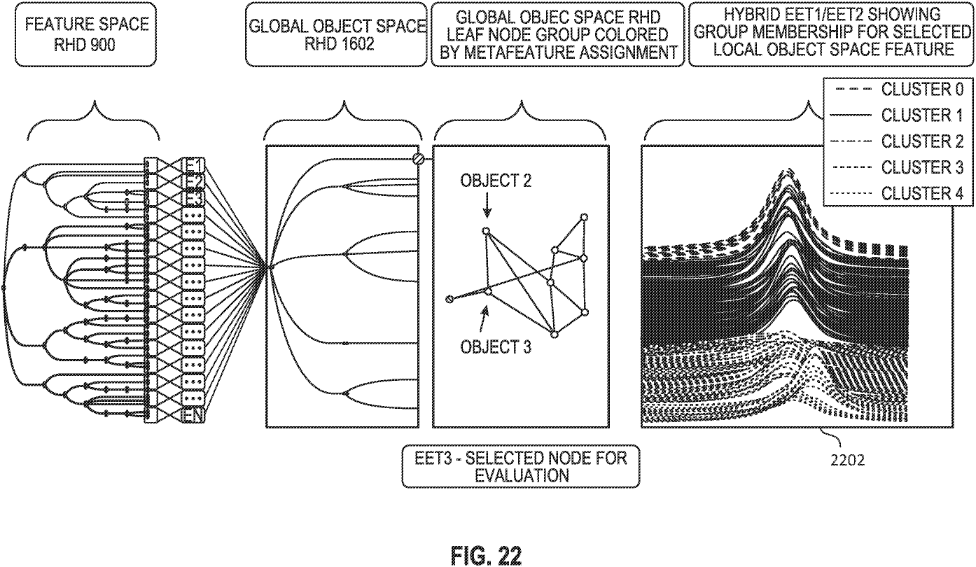

FIG. 22 depicts the hybrid EET1/EET2 showing group membership for selected local object space feature(s) in some embodiments. A global object space RHD leaf node can be colored by the underlying selected statistical features. FIG. 2202 depicts the hybrid EET1/EET2 local object space group membership as a defining feature for the selected group. Similarly, the global object space RHD can be colored by membership of metafeature group cluster assignment (blue=member of cluster 0, red = not a member of cluster 0).

In various embodiments, the visualization module 316 and/or the communication module 302 may track all transformations, and beddings, data, centroids, visualizations, and or the like and save the information a longer audit file. It will be appreciated that each step of the process from receiving of data, generating any of the connected-component networks, to projections/embeddings, identification of centroids, identification of branch points, identification of meta-features, data array creation, and/or the like can be tracked and stored for further explain ability and audit-ability. In various embodiments, a user (e.g., from a user device) may perform analysis and review the audit regarding the process for identifying inherent relationships, explanations, and the like. These audits may be useful to confirm steps, add clarity, identify areas of improvement or error, and strengthen acceptance of any conclusions.

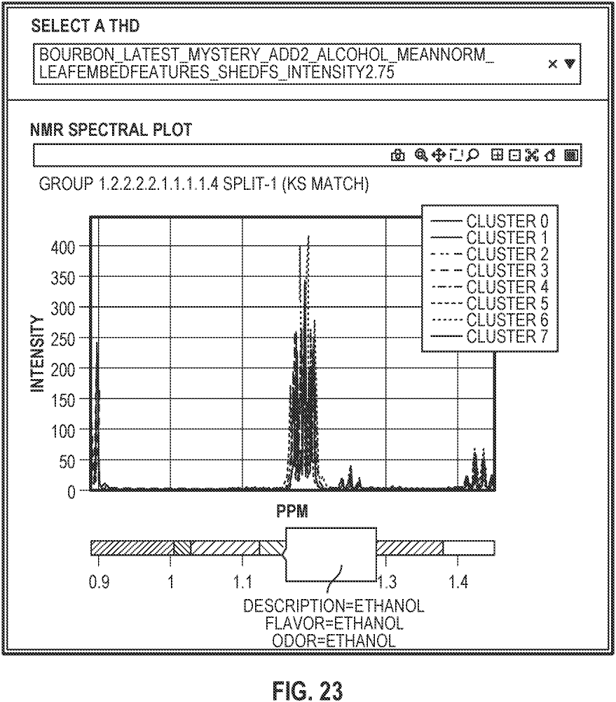

FIG. 23 depicts an interactive visualization in some embodiments. FIG. 23 depicts an example graphical user interface (GUI) for exploring unique feature sets that distinguish bourbons (e.g., using methods and/or systems described herein).

In one example of a process using methods and systems described herein is applied to bourbon analysis (e.g., analysis of bourbon). In prior analysis (unrelated to systems discussed herein) based on flavor tests, wheat bourbon’s have been determined to beat rye bourbons, 12 month stave seasoning beats 6-month stave seasoning, coarse grain is preferred over average/tight, hundred 25 entry proof beats 105 entered proof, ripped warehouse beats concrete, bottom half of tree beats top half of the tree, harvest location be beats harvest location A, and char number four char number three. Barrel #80 was identified as the most preferred which was a ride bourbon, 125 entry proof, concrete warehouse, number four char, seasoned 12 month staves, bottom half of tree, and low rings per inch. In the prior analysis however, there are huge variations across customer reviews, sensory profiles, and customer preferences and general (even in expert panels).

In this example, the methodologies described herein may be applied to:
develop analytical chemistry machine learning pipelines that can develop and exploit novel patterns within the data,
develop sensory analysis methods that provide proper normalization segmentation and conductivity of metadata features across data sets, and
create highly integrated approach that enables deeper and faster identification of complex interactions that influence bourbon taste and customer preference.

The method outlined in FIG. 1 may be applied to the 80+ chemical compounds that are detected, quantified, and correlated with SOP variables and customer reviews. The data may be derived in part from gas chromatograph analysis of different bourbons. Gas chromatograph data shows that SOP bourbons largely stratified based on five variables and to a lesser extent across experimental variables. The five variables include recipe, installation date — stave seasoning, entry proof, entry weight, and harvest location. AI approaches link customer scoring and chemical composition both globally (e.g., using chemical compounds) and at the individual chemical compound level. In this example, hundred and nine SOP barrels are included in the analysis.

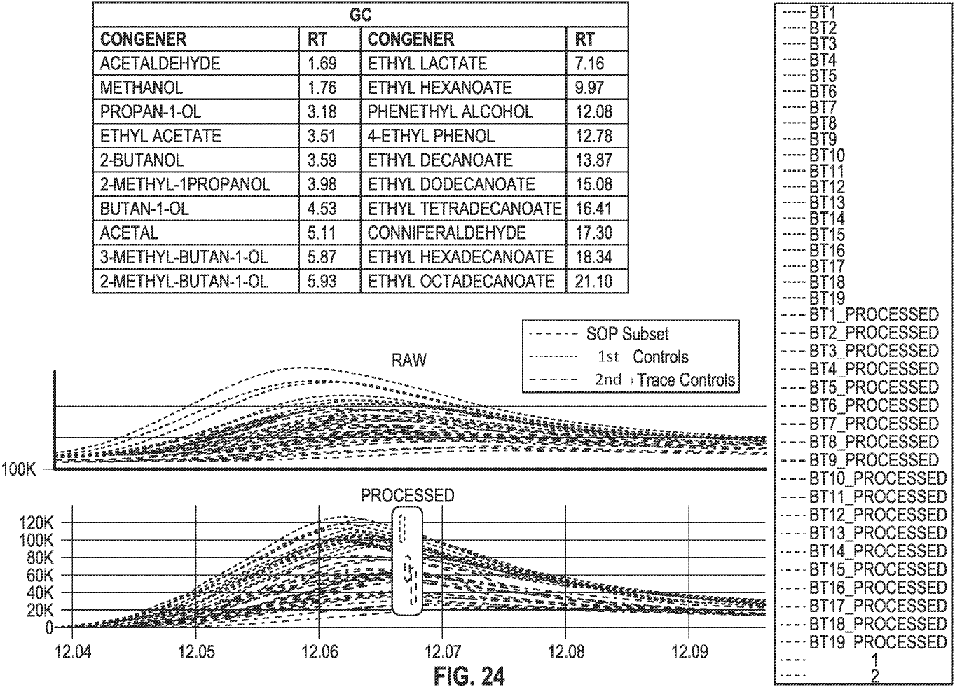

FIG. 24 is an example of a feature description for bourbons that is derived from the feature space RHD. Here, a specific range of the feature space is isolated. The user can interrogate specific traces pre-and post normalization and embeddings that may be colored by specific meta-features.

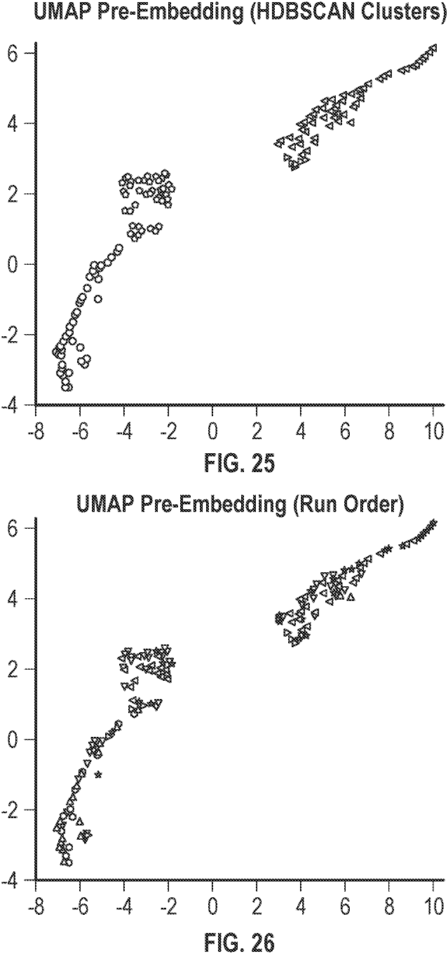

FIG. 25 depicts an example UMAP pre-embedding (HDBSCAN clusters).

FIG. 26 depicts an example UMAP pre-embedding (run order).

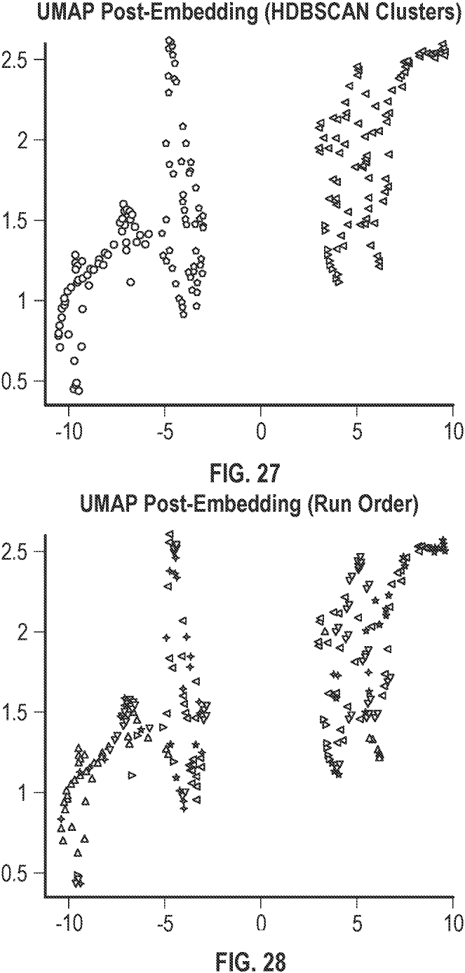

FIG. 27 depicts an example UMAP post-embedding (HDBSCAN clusters).

FIG. 28 depicts an example UMAP post-embedding (run order).

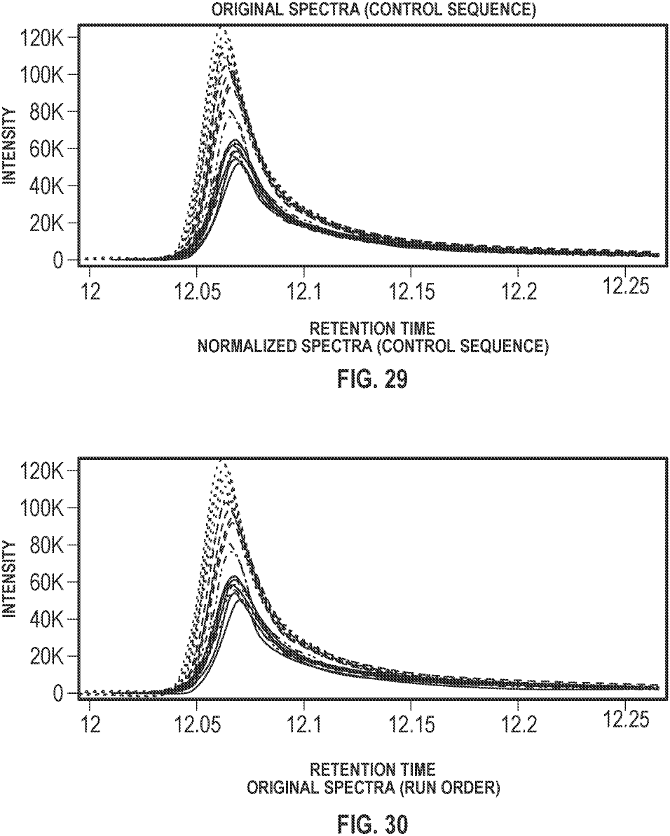

FIG. 29 depicts an example original spectra (control sequence). In this example, intensity is along the y-axis and retention time normalized spectra is along the x-axis.

FIG. 30 depicts an example retention time normalized spectra (run order) along the x-axis and intensity along the y-axis.

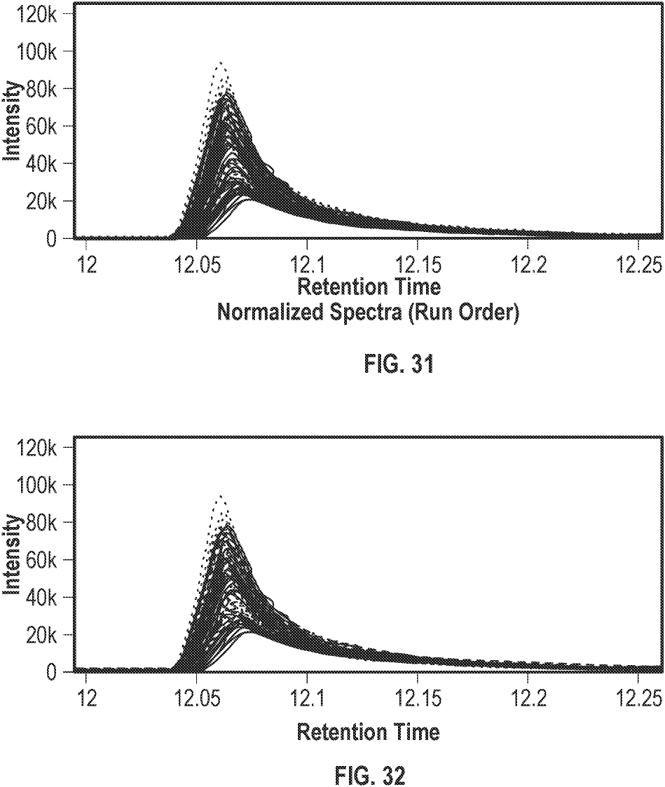

FIG. 31 depicts an example retention time normalized spectra (run order) along the x-axis and intensity along the y-axis.

FIG. 32 depicts an example retention time along the x-axis and intensity along the y-axis.

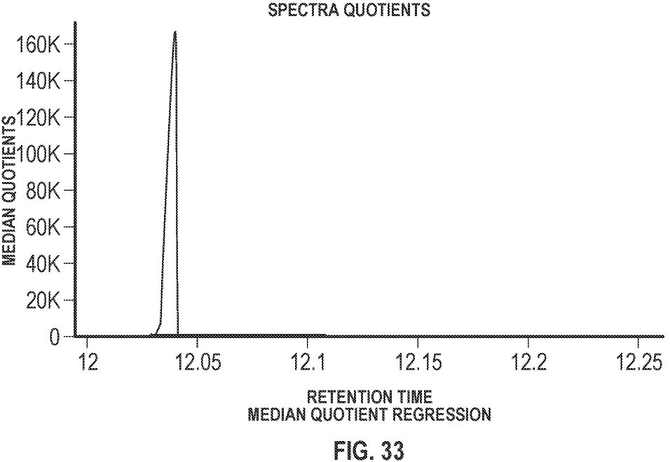

FIG. 33 depicts example spectra quotients (e.g., from the gas chromatograph). Median quotients are along the y-axis and the retention time (median quotient regression) is along the x-axis.

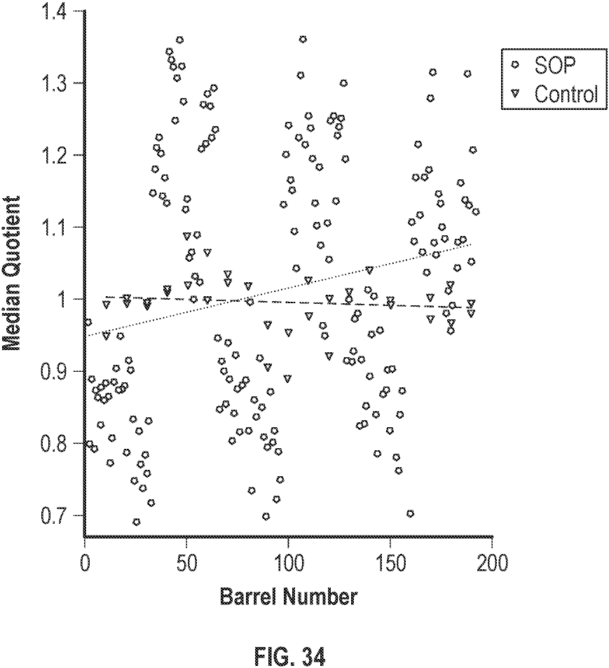

FIG. 34 depicts an example graph of SOP and control with the median quotient along the y-axis and the barrel number (e.g., for the specific barrel of bourbon) along the x-axis.

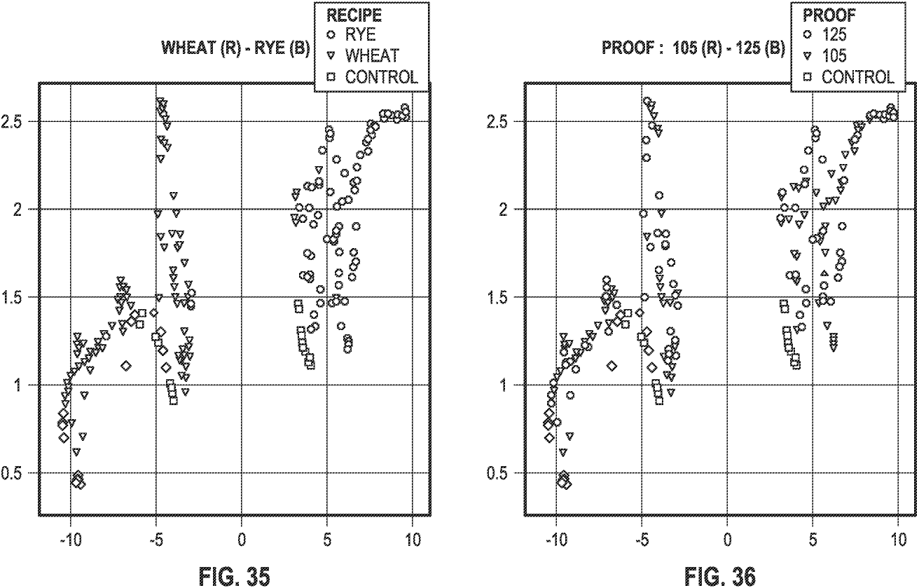

FIG. 35 depicts an example wheat to rye graph.

FIG. 36 depicts a proof 105 to proof 125 graph.

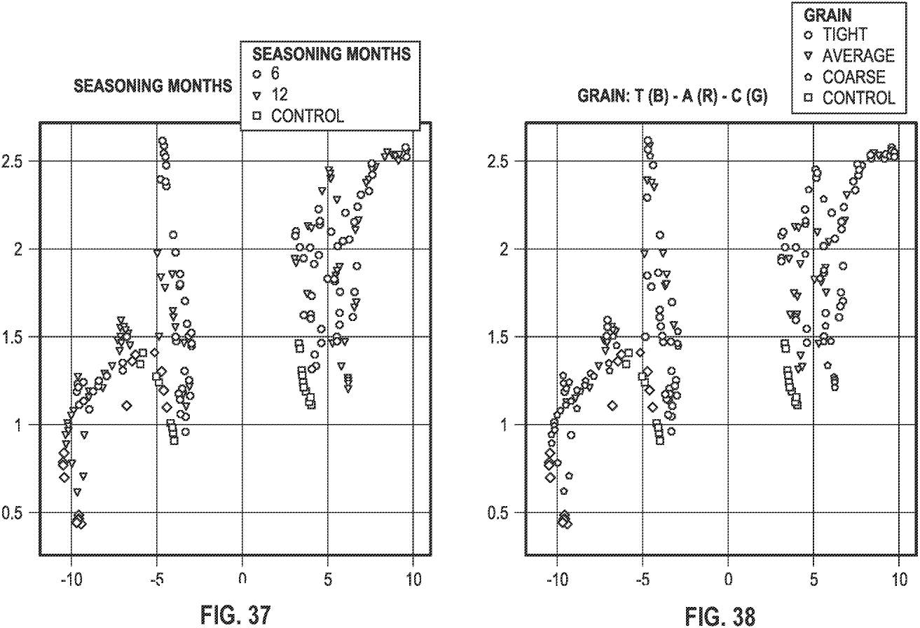

FIG. 37 depicts an example graph for seasoning of staves (e.g., comparison of 6 to 12 months).

FIG. 38 depicts an example graph of grain comparison (e.g., tight, average, coarse, and control).

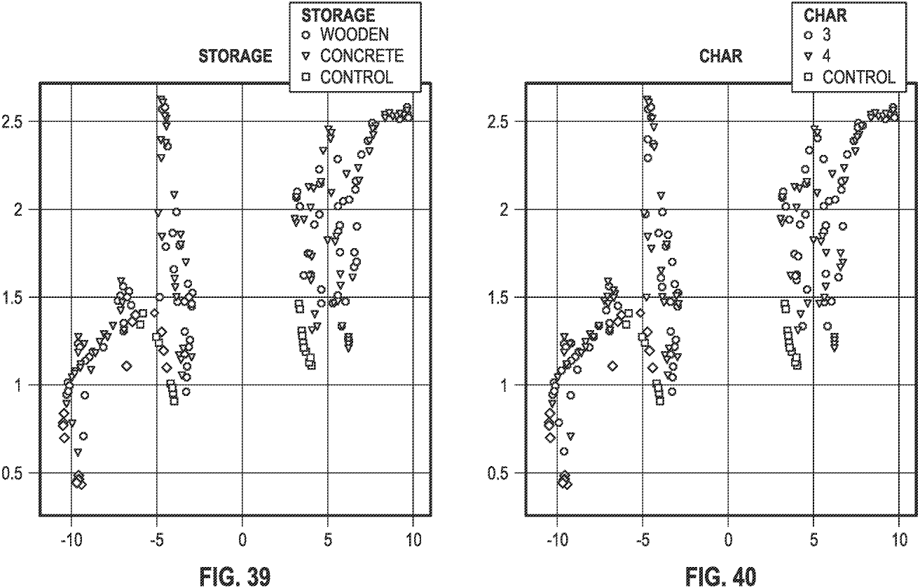

FIG. 39 depicts an example storage graph for comparison of wooden to concrete).

FIG. 40 depicts an example char graph for comparing type #3 char to type #4 char.

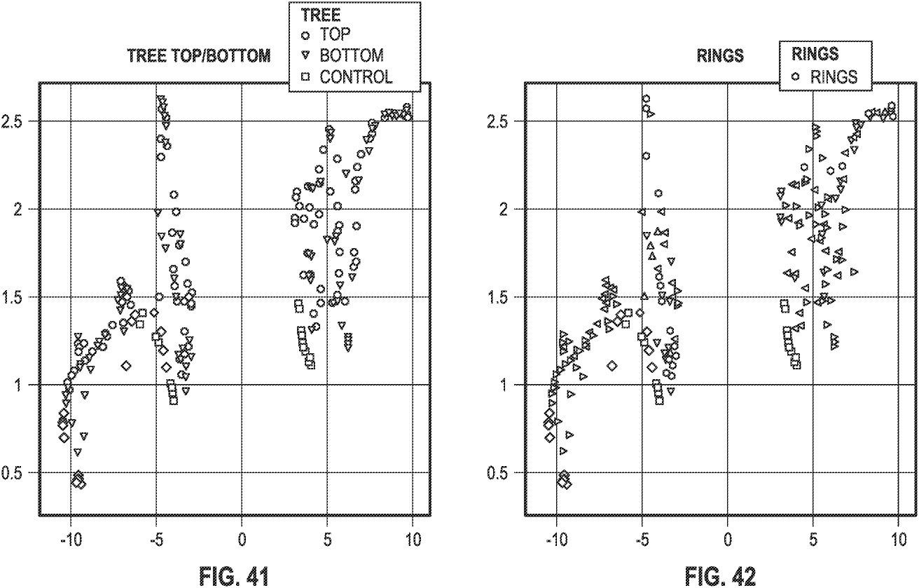

FIG. 41 depicts an example tree graph for comparison of top of tree to bottom of tree.

FIG. 42 depicts an example ring graph for comparison of the number of rings.

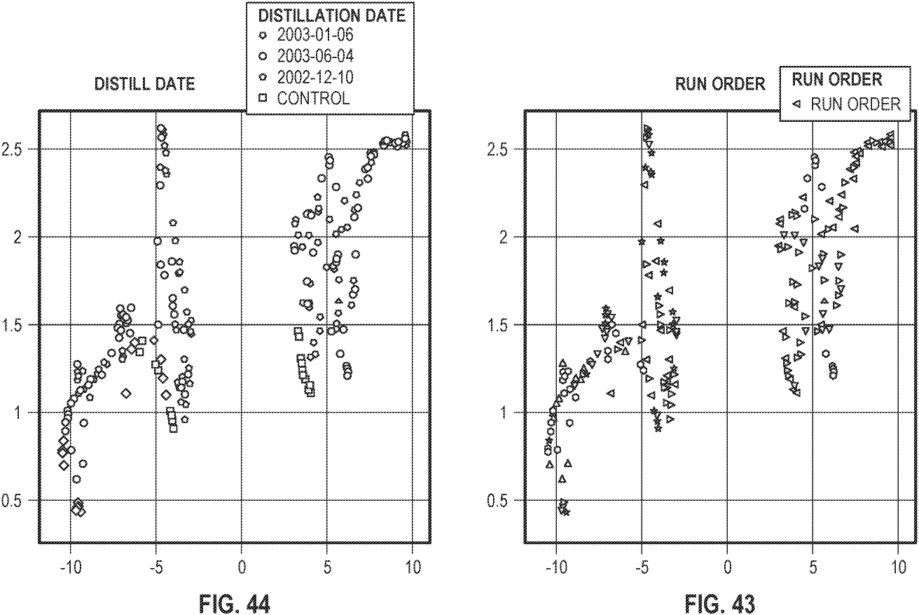

FIG. 43 depicts a run order graph for a comparison of different run orders.

FIG. 44 depicts an example distill graph for comparison of different distillation dates.

FIG. 45 depicts a block diagram of an example digital device 4500 according to some embodiments. The digital device 4500 is shown in the form of a general-purpose computing device. The digital device 4500 includes at least one processor 4502, RAM 4504, communication interface 4506, input/output device 4508, storage 4510, and a system bus 4512 that couples various system components including storage 4510 to the at least one processor 4502. A system, such as a computing system, may be or include one or more of the digital device 4500.

System bus 4512 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 4500 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 4502 is configured to execute executable instructions (for example, programs). In some embodiments, the at least one processor 4502 comprises circuitry or any processor capable of processing the executable instructions.

In some embodiments, RAM 4504 stores programs and/or data. In various embodiments, working data is stored within RAM 4504. The data within RAM 4504 may be cleared or ultimately transferred to storage 4510, such as prior to reset and/or powering down the digital device 4500.

In some embodiments, the digital device 4500 is coupled to a network, such as the communication network 112, via communication interface 4506.

In some embodiments, input/output device 4508 is any device that inputs data (for example, mouse, keyboard, stylus, sensors, etc.) or outputs data (for example, speaker, display, virtual reality headset).

In some embodiments, storage 4510 can include computer system readable media in the form of non-volatile memory, such as read only memory (ROM), programmable read only memory (PROM), solid-state drives (SSD), flash memory, and/or cache memory. Storage 4510 may further include other removable/non-removable, volatile/non-volatile computer system storage media. By way of example only, storage 4510 can be provided for reading from and writing to a non-removable, non-volatile magnetic media. The storage 4510 may include a non-transitory computer-readable medium, or multiple non-transitory computer-readable media, which stores programs or applications for performing functions such as those described herein. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 4512 by one or more data media interfaces. As will be further depicted and described below, storage 4510 may include at least one program product having a set (for example, at least one) of program modules that are configured to carry out the functions of embodiments of the invention. In some embodiments, RAM 4504 is found within storage 4510.

Programs/utilities, having a set (at least one) of program modules, such as the computer vision pipeline system 104, may be stored in storage 4510 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with the digital device 4500. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program or data for use by or in connection with an instruction execution system, apparatus, or device.

A transitory computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled”, “couplable”, “operably coupled”, “communicably coupled” and the like to other components. Such description or illustration should be understood as indicating that such components may cooperate or interact with each other, and may be in direct or indirect physical, electrical, or communicative contact with each other.

Components may be described or illustrated as “configured to”, “adapted to”, “operative to”, “configurable to”, “adaptable to”, “operable to” and the like. Such description or illustration should be understood to encompass components both in an active state and in an inactive or standby state unless required otherwise by context.

It may be apparent that various modifications may be made, and other embodiments may be used without departing from the broader scope of the discussion herein. Therefore, these and other variations upon the example embodiments are intended to be covered by the disclosure herein.

1. A non-transitory computer readable medium comprising executable instructions, the executable instructions being executable by one or more processors to perform a method, the method comprising:
receiving analysis data from at least one data source;
projecting the analysis data to a first embedding based on at least one metric;
determining a first lowest cover resolution of the first embedding that identifies non-overlapping secondary coverings based on sets within one of the covers of the first embedding;
identifying a branch point of a first connected-component network based on the non-overlapping secondary coverings;
generating subsets from the branch point based on the non-overlapping secondary coverings;
if a network generation threshold has not been met, then for each subset from the branch point, determining a second lowest cover resolution that identifies non-overlapping secondary coverings based on the sets within one of the covers of a particular subset to identify a new branch point and new subsets from that branch point of the first connected-component network;
for each leaf of the connected-component network, identify embeddings of a feature space and generate a local object embedding space using a transposition of segmented features with related objects;
adding coordinates of objects within each leaf of the local object embedding to a data array;
projecting array data from the data array to a second embedding;
determining a third lowest cover resolution of the second embedding that identifies non-overlapping secondary coverings based on sets within one of the covers of the second embedding;
identifying a branch point of a second connected-component network based on the non-overlapping secondary coverings;
generating subsets from the branch point based on the non-overlapping secondary coverings;
if a network generation threshold has not been met, then for each subset from the branch point, determining a second lowest cover resolution that identifies non-overlapping secondary coverings based on the sets within one of the covers of a particular subset to identify a new branch point and new subsets from that branch point of the second connected-component network; and
generating a visualization depicted centroids of leaves and branches within the second connected-component network.

2. The non-transitory computer-readable medium of claim 1, further comprising generating the secondary coverings by determining, for each set that has data within the cover, a centroid and determining a radius based on the centroid that covers at least that particular set.

3. The non-transitory computer-readable medium of claim 2, wherein the centroid for a particular set is determined based on the data within that particular set.

4. The non-transitory computer-readable medium of claim 1, wherein the first embedding comprises a metric space containing projected data, the projected data being one to one in the first embedding.

5. The non-transitory computer-readable medium of claim 1, wherein new branch points and new segments are determined based on new non-overlapping secondary coverings until the network generation threshold is met.

6. The non-transitory computer-readable medium of claim 1, wherein projecting the array data from the data array to the second embedding uses at least the same metric as projecting the received data to the first embedding.

7. The non-transitory computer-readable medium of claim 1, for each leaf of the first connected-component network, projecting the leaf data of that leaf into a separate embedding and determining non-overlapping secondary coverings at the lowest resolution covering of that particular separate embedding to identify metafeature groups.

8. The non-transitory computer-readable medium of claim 7, wherein object membership of each metafeature group of each leaf is added to the data array.

9. The non-transitory computer-readable medium of claim 8, wherein the object membership of each metafeature group of each leaf is added to the data array before projecting the array data from the data array to the second embedding.

10. A system comprising at least one processor and memory containing instructions, the instructions being executable by the at least one processor to:
receive analysis data from at least one data source;
project the analysis data to a first embedding based on at least one metric;
determine a first lowest cover resolution of the first embedding that identifies non-overlapping secondary coverings based on sets within one of the covers of the first embedding;
identify a branch point of a first connected-component network based on the non-overlapping secondary coverings;
generate subsets from the branch point based on the non-overlapping secondary coverings;
if a network generation threshold has not been met, then for each subset from the branch point, determine a second lowest cover resolution that identifies non-overlapping secondary coverings based on the sets within one of the covers of a particular subset to identify a new branch point and new subsets from that branch point of the first connected-component network;
for each leaf of the connected-component network, identify embeddings of a feature space and generate a local object embedding space using a transposition of segmented features with related objects;
add coordinates of objects within each leaf of the local object embedding to a data array;
project array data from the data array to a second embedding;
determine a third lowest cover resolution of the second embedding that identifies non-overlapping secondary coverings based on sets within one of the covers of the second embedding;
identify a branch point of a second connected-component network based on the non-overlapping secondary coverings;
generate subsets from the branch point based on the non-overlapping secondary coverings;
if a network generation threshold has not been met, then for each subset from the branch point, determine a second lowest cover resolution that identifies non-overlapping secondary coverings based on the sets within one of the covers of a particular subset to identify a new branch point and new subsets from that branch point of the second connected-component network; and
generate a visualization depicted centroids of leaves and branches within the second connected-component network.

11. The system of claim 10, the instructions being further executable by the at least one processor to generate the secondary coverings by determining, for each set that has data within the cover, a centroid and determining a radius based on the centroid that covers at least that particular set.

12. The system of claim 11, wherein the centroid for a particular set is determined based on the data within that particular set.

13. The system of claim 10, wherein the first embedding comprises a metric space containing projected data, the projected data being one to one in the first embedding.

14. The system of claim 10, wherein new branch points and new segments are determined based on new non-overlapping secondary coverings until the network generation threshold is met.

15. The system of claim 10, wherein projecting the array data from the data array to the second embedding uses at least the same metric as projecting the received data to the first embedding.

16. The system of claim 10, for each leaf of the first connected-component network, the instructions are further executable by the at least one processor to project the leaf data of that leaf into a separate embedding and determining non-overlapping secondary coverings at the lowest resolution covering of that particular separate embedding to identify metafeature groups.

17. The system of claim 16, wherein object membership of each metafeature group of each leaf is added to the data array.

18. The system of claim 17, wherein the object membership of each metafeature group of each leaf is added to the data array before projecting the array data from the data array to the second embedding.

19. A method comprising:
receiving analysis data from at least one data source;
projecting the analysis data to a first embedding based on at least one metric;
determining a first lowest cover resolution of the first embedding that identifies non-overlapping secondary coverings based on sets within one of the covers of the first embedding;
identifying a branch point of a first connected-component network based on the non-overlapping secondary coverings;
generating subsets from the branch point based on the non-overlapping secondary coverings;
if a network generation threshold has not been met, then for each subset from the branch point, determining a second lowest cover resolution that identifies non-overlapping secondary coverings based on the sets within one of the covers of a particular subset to identify a new branch point and new subsets from that branch point of the first connected-component network;
for each leaf of the connected-component network, identify embeddings of a feature space and generate a local object embedding space using a transposition of segmented features with related objects;
adding coordinates of objects within each leaf of the local object embedding to a data array;
projecting array data from the data array to a second embedding;
determining a third lowest cover resolution of the second embedding that identifies non-overlapping secondary coverings based on sets within one of the covers of the second embedding;
identifying a branch point of a second connected-component network based on the non-overlapping secondary coverings;
generating subsets from the branch point based on the non-overlapping secondary coverings;
if a network generation threshold has not been met, then for each subset from the branch point, determining a second lowest cover resolution that identifies non-overlapping secondary coverings based on the sets within one of the covers of a particular subset to identify a new branch point and new subsets from that branch point of the second connected-component network; and
generating a visualization depicted centroids of leaves and branches within the second connected-component network.
